(19) United States
(12) Patent Application Publication
(10) Pub. No.: US 2013/0229404 A1
(43) Pub. Date: Sep. 5, 2013

(54) IMAGE DATA TRANSMISSION SYSTEM AND ELECTRONIC DEVICE

(71) Applicants: Yoshihisa Ishida, Nara (JP); Naru Yasuda, Uji-shi (JP); Hayami Hosokawa, Tsuzuki-gun (JP)

(72) Inventors: Yoshihisa Ishida, Nara (JP); Naru Yasuda, Uji-shi (JP); Hayami Hosokawa, Tsuzuki-gun (JP)

(73) Assignee: OMRON CORPORATION, Kyoto (JP)

(21) Appl. No.: 13/818,586

(22) PCT Filed: Mar. 16, 2011
(86) PCT No.: PCT/JP2011/056223

§ 371 Date: May 20, 2013

(30) Foreign Application Priority Data
Sep. 17, 2010 (JP) JP2010-209393

(51) Int. Cl. G09G 3/36

(52) U.S. Cl. CPC G09G 3/36
USPC 345/212; 345/87

(57) ABSTRACT

A transmission unit sequentially outputs a plurality of data signals in a predetermined transmission period during which a one-frame image is transmitted, the predetermined transmission period being defined by a product of a number of the given units and a transmission period of a given unit. Meanwhile, the transmission unit outputs a control signal in the period among the predetermined transmission period that is equivalent to a sum of the transmission time of the given units which does not include the data signals. This period corresponds to the sleep mode period of the transmission unit. The sleep mode period is set such that a ratio of the sleep mode period to the predetermined transmission period is larger than a ratio of a sum of a transmission period of the control signal and a margin period for transmission of the control signal to the predetermined transmission period.

### BACKGROUND OF INVENTION

1. Technical Field

The present invention relates to an image data transmission system that transmits image data, and to an electronic device provided with the system.

2. Background Art

In order to display an image on a screen of a display device, generally the image from an upper left corner of the screen to a lower right corner of the screen is drawn one line by one line. A period from the end of the display of the image on a certain line to the beginning of the display of the image on the next line is called a horizontal blanking period. On the other hand, a period from the end of the drawing on the bottom line of the screen to the beginning of the drawing on the top line of the screen is called a vertical blanking period.

Nowadays a liquid crystal display device is widely used as a display device that displays the image (including a moving image and a still image). For example, the liquid crystal display device is mounted on a mobile terminal device typified by a mobile phone. There is a need to reduce power consumption of the liquid crystal display device in order to lengthen an operation time of the mobile terminal device.

For example, Japanese Unexamined Patent Publication No. 8-305316 (Patent Document 1) discloses a configuration in order to reduce power consumption of a driving circuit of the liquid crystal display element. According to Patent Document 1, the display device includes means for stopping a dock signal supplied to the driving circuit in the horizontal blanking period and the vertical blanking period. Therefore, the power consumption of the driving circuit can be reduced in the horizontal blanking period and the vertical blanking period.

However, in the case that the blanking period is simply added, unfortunately a frame rate is decreased. In the display system, it is necessary to avoid the decrease in frame rate.

Japanese Unexamined Patent Publication No. 2002-341831 (Patent Document 2) discloses a method for implementing a transmission sion rate, which can correspond to an increase in the amount of display data, with low power consumption. According to Patent Document 2, a memory in which one-frame display data is stored is mounted on the display. In a dummy blanking period, the data is transferred from the processor to the memory, and the data is stored in the memory. The data transfer from the processor to the memory is stopped after the necessary display data is transferred from the processor to the memory. Therefore, the reduction of the power consumption can be achieved.

According to the technology disclosed in Patent Document 1, the driving circuit is stopped in the blanking period, so that the reduction of the power consumption of the driving circuit can be achieved. However, generally the blanking period is set only in a period necessary to process a control signal in real time. Therefore, the blanking period is shorter than a period during which the image data is displayed. Accordingly, even if the driving circuit is stopped in the blanking period in a one-frame transmission period, it is difficult to largely reduce the power consumption of the driving circuit.

According to the technology disclosed in Patent Document 2, as long as the image data is transmitted from the processor to the memory (that is, as long as the image displayed on the display device is updated), the data necessary to redraw the image on the display device is supplied from the memory to the display. Therefore, it is expected that the power consumption of the processor can largely be reduced. However, in the Patent Document 2, unfortunately cost is increased and it is necessary to ensure an extra device mounting domain.

An object of at least one embodiment of the present invention is to reduce the power consumption of the transmission system that transmits the image data.

### SUMMARY

In accordance with one aspect of at least one embodiment of, an image data transmission system includes: a transmission unit that outputs plural data signals and a control signal, the data signals being generated by dividing a one-frame image in given units, the control signal being used to control timing at which predetermined processing is performed based on the data signals; a receiving unit that receives the data signals and the control signal; and a wiring unit through which the data signals and the control signal are transmitted from the transmission unit to the receiving unit. The transmission unit sequentially outputs the plural data signals in a predetermined transmission period during which the one frame image is transmitted, the predetermined transmission period being defined by a product of a number of the given units and a transmission period of the given unit, and the transmission unit outputs the control signal in a first period of first and second periods, the data signals being not output in the first and second periods. The first period is a period that is equal to a sum of transmission time of the given units which does not include the data signals in the predetermined transmission period. When the first period is defined as a sleep mode period of the transmission unit, the sleep mode period is set such that a ratio of the sleep mode period to the predetermined transmission period is larger than a ratio of a sum of a transmission period of the control signal and a margin period for transmission of the control signal to the predetermined transmission period. The second period may be a period that is equal to a sum of difference times in each of which a transmission period of the data signals is subtracted from the given-unit transmission period including the data signals in the predetermined transmission period.

In accordance with another aspect of at least one embodiment of, an image data transmission system includes: a transmission unit that outputs plural data signals and a control signal, the data signals being generated by dividing a one-frame image in given units, the control signal being used to control timing at which predetermined processing is performed based on the data signals; a receiving unit that receives the data signals and the control signal; and a wiring unit through which the data signals and the control signal are transmitted from the transmission unit to the receiving unit. The transmission unit sequentially outputs the plural data signals in a predetermined transmission period during which the one frame image is transmitted, and the transmission unit outputs the control signal in a first period of first and second periods, the data signals being not output in the first and second periods. The first period is a period that is equal to a sum of transmission time of the given units which does not include the data signals in the predetermined transmission period. The second period is a period that is equal to the sum of time difference obtained by subtracting data signals transmission periods from a transmission period of the given units including the data signals in the predetermined transmission period. When the second period is defined as a sleep mode period of the transmission unit, the sleep mode period is set such that a ratio of the sleep mode period to the predetermined transmission period is larger than a ratio of a sum of a transmission period of the control signal and a margin period for transmission of the control signal to the predetermined transmission period.

Although the term of the “image” includes a photograph, a picture, a character, a graphic, and a symbol, the “image” is not limited to these words. The “image” may be either a still image or a moving image.

For example, the “predetermined processing based on the data signal” includes image display processing, image data storing processing, and image data transferring processing. However, the “predetermined processing based on the data signal” is not limited to these pieces of processing.

The “sleep mode period” is a period during which the power consumption of the transmission unit is decreased compared with the data transmission period.

For example, the “given unit” is determined according to the “predetermined processing”. For example, the number of “given units” is greater than or equal to the number of lines of the image. That is, the number of “given units” may be equal to the number of lines of the image.

According to the configuration, the ratio of the sleep mode period to the one-frame transmission period can be increased. Therefore, the power consumption of the image data transmission system can be reduced.

Preferably the transmission unit outputs the control signal in both the first and second periods. When the first and second periods are defined as the sleep mode period, the sleep mode period is set such that a ratio of the sleep mode period to the predetermined transmission period is larger than a ratio of a sum of a transmission period of the control signal and a margin period for transmission of the control signal to the predetermined transmission period.

According to the configuration, because the ratio of the sleep mode period to the predetermined transmission period can further be increased, the power consumption of the image data transmission system can further be reduced.

Preferably the control signal transmitted in the first period includes a vertical synchronous signal. A sum of a transmission period of the vertical synchronous signal and the margin period for transmission of the vertical synchronous signal is less than or equal to 20% of the predetermined transmission period.

Preferably the control signal transmitted in the second period includes a horizontal synchronous signal. The margin period for transmission of the horizontal synchronous signal is less than or equal to ten times a transmission period of the horizontal synchronous signal.

In accordance with still another aspect of at least one embodiment of, an image data transmission system includes: a transmission unit that outputs plural data signals and a control signal, the data signals being generated by dividing a one-frame image in given units, the control signal being used to control timing at which predetermined processing is performed based on the data signals; a receiving unit that receives the data signals and the control signal; and a wiring unit through which the data signals and the control signal are transmitted from the transmission unit to the receiving unit. The transmission unit includes first and second transmission modes in which the plural data signals are sequentially output in a predetermined transmission period during which the one-frame image is transmitted, and the transmission unit transitions to a sleep mode in which power consumption of the transmission unit is decreased compared with an output time of the data signals when the output of the data signals is stopped. The transmission unit enhances a transmission speed of the data signals in the second transmission mode compared with the first transmission mode, whereby the transmission unit increases a ratio of the sleep mode period to the predetermined transmission period compared with the ratio in the first transmission mode.

According to the configuration, the ratio of the sleep mode period to the one-frame transmission period can be increased by enhancing the transmission speed of the data signals. Therefore, the power consumption of the image data transmission system can be reduced.

Preferably a rate of increase in power consumption of the transmission unit is less than or equal to a proportion of a second speed to a first speed when a transmission speed of the transmission unit increases from the first speed to the second speed.

According to the configuration, the data transmission period can be shortened by enhancing the transmission speed. Therefore, the power consumption of the transmission unit can be reduced because the ratio of the sleep mode period to the predetermined transmission period can be increased. However, the power consumption of the transmission unit is increased in the data transmission period by enhancing the transmission speed. Accordingly, when the transmission speed of the transmission unit is enhanced from the first speed (for example, the original speed) to the second speed (for example, the post-change speed), the rate of increase in power consumption of the transmission unit is less than or equal to the proportion of the second speed to the first speed. Therefore, even if the transmission speed is enhanced, the large increase in power consumption of the transmission unit can be controlled in the data transmission period. Accordingly, the effect to reduce the power consumption of the transmission unit is further enhanced.

Preferably the transmission unit sets a period, during which both the data signals and the control signal are not transmitted, in the sleep mode period.

According to the configuration, the sleep mode period can be lengthened by setting the period, during which both the data signals and the control signal are not transmitted, in the sleep mode period. Accordingly, the power consumption of the transmission system can be reduced.

Preferably the given unit is one line. A transmission period corresponding to the one line and the sleep mode period are integral multiples of a cycle of a clock signal used in the transmission unit.

According to the configuration, the sleep mode period can easily be set (for example, adds the period during which both the data signals and the control signal are not transmitted) in the transmission period corresponding to the one line.

Preferably the wiring unit includes signal wiring that is configured to transmit at least the data signals of the data signals and the control signal by a differential serial transmission method.

A data size of the data signals is larger than that of the control signal. According to the configuration, in the interface unit, the transmission rate of the data signals can be enhanced because the data signals are transmitted by the differential serial transmission method. Therefore, the data transmission period can be shortened in the data transmission system. Accordingly, the power consumption of the transmission system can be reduced.

Preferably the wiring unit includes an optical wiring module that nsmits at least the data signals of the data signals and the control signal in a form of an optical signal.

According to the configuration, in the interface unit, the transmission rate of the data signals can be enhanced because the data signals are transmitted in the form of the optical signal. The use of the optical wiring module can shorten a length of the electric wiring unit by a length of the optical wiring module. Therefore, a transmission loss is reduced, and an influence of waveform degradation caused by a parasitic capacitance is also reduced, so that an upper limit of the transmission rate of the electric wiring unit can be enhanced. The optical wiring is smaller than the electric wiring in the transmission loss, and the signal is transmitted without the influence of EMI, so that the transmission speed can be enhanced in the optica wiring compared with the electric wiring. Accordingly, the transmission speed higher than the transmission speed of the electric wiring can be achieved. Because the data transmission period can be shortened in the data transmission system, the power consumption of the transmission system can be reduced.

Preferably a transmission speed per lane of the optical wiring module is greater than or equal to 500 Mbps.

According to the configuration, the transmission speed higher than that of the electric wiring can be implemented. Additionally, the effect to reduce the power consumption of the transmission system is enhanced compared with the data signal transmission through the electric wiring.

Preferably the receiving unit outputs the data signals and the control signal to a display device. The predetermined processing is processing of displaying the one-frame image, which is performed by the display device.

According to the configuration, the power consumption of the system that transmits the image data signals to the display device can be reduced. The power consumption of the display device can also be reduced in the period during which the one-frame image is transmitted from the system to the display device.

Preferably the display device includes a memory. Data of the one-frame image corresponding to the data signals is stored in the memory.

According to the configuration, the image data stored in the memory can be used in refreshing the image displayed on the display device. Therefore, the power consumption of the transmission system can be reduced.

Preferably the transmission unit transmits the data signal corresponding to an image captured by a camera.

According to the configuration, the power consumption of the system that transfers the image captured by the camera can be reduced. The power consumption of the camera can also be reduced in the period during which the one-frame image is transmitted from the camera through the system.

Preferably the transmission unit transmits data corresponding to the one-frame image, which is received by a wireless communication unit, as the data signals.

According to the configuration, the power consumption of the system that transfers the image obtained by the wireless communication unit can be reduced. Additionally, the power consumption of the wireless communication unit can be reduced in the period during which the one-frame image is transmitted from the wireless communication unit through the system.

Preferably the receiving unit outputs the data signals to a wireless communication unit. The wireless communication unit wirelessly transmits the data signal.

According to the configuration, the power consumption of the system that transfers the image data to the wireless communication unit, which wirelessly transmits the image data, can be reduced. Additionally, the power consumption of the wireless communication unit can be reduced in the period during which the data corresponding to the one-frame image is transmitted from the transmission system to the wireless communication unit.

In accordance with yet another aspect of at least one embodiment of, an electronic device includes the image data transmission system.

Preferably the electronic device is a mobile terminal device.

According to the configuration, the power consumption of the electronic device including the image data transmission system can be reduced. Particularly, because the power consumption of the mobile terminal device can be reduced, an operating time of the mobile terminal device can be lengthened.

According to at least one embodiment of, the power consumption of the transmission system that transmits the image data can be reduced.

### BRIEF DESCRIPTION OF THE DRAWINGS

FIG. 1 is a block diagram illustrating a schematic configuration of an electronic device including an image data transmission system according to an embodiment of the present invention.

FIG. 2 is a functional block diagram of a transmission unit 1 in FIG. 1.

FIG. 3 is a view illustrating a horizontal blanking period and a vertical blanking period.

FIG. 4 is a timing chart illustrating an example of an operation of the transmission unit in order to perform display processing in FIG. 3.

FIG. 5 is a view illustrating a vertical blanking period added by a transmission unit according to a first embodiment.

FIG. 6 is a timing chart illustrating an operation of the transmission unit 1 of the first embodiment.

FIG. 7 is a view illustrating a clock signal CLK prescribing signal transmission performed by the transmission unit 1 of the first embodiment.

FIG. 8 is a view illustrating a relationship between an increasing amount of an image data transmission speed and an increasing amount of power consumption of the transmission unit 1.

FIG. 9 is a view illustrating a horizontal blanking period added by a transmission unit according to a second embodiment.

FIG. 10 is a timing chart illustrating an operation of the transmission unit 1 of the second embodiment.

FIG. 11 is a view illustrating a relationship between one-line transmission period (a horizontal scanning period) and horizontal blanking periods HBL1 and HBL2.

FIG. 12 is a first view illustrating a blanking period added by a transmission unit according to a third embodiment.

FIG. 13 is a timing chart illustrating display processing in FIG. 12.

FIG. 14 is a second view illustrating the blanking period added by the transmission unit of the third embodiment.

FIG. 15 is a third view illustrating the blanking period added by the transmission unit of the third embodiment.

FIG. 16 is a view illustrating a schematic configuration of an electronic device including a transmission system according to a fourth embodiment.

FIG. 17 is a view illustrating a configuration example of a differential serial interface circuit.

FIG. 18 is a view illustrating an effect of the differential serial interface circuit.

FIG. 19 is a timing chart illustrating an operation of a transmission unit 1 of the fourth embodiment.

FIG. 20 is a view illustrating a modification of the fourth embodiment.

FIG. 21 is a view illustrating a schematic configuration of an electronic device including a transmission system according to a fifth embodiment.

FIG. 22 is a view illustrating a configuration example of an optical wiring module in FIG. 21.

FIG. 23 is a view illustrating a modification of the fifth embodiment.

FIG. 24 is a view illustrating a schematic configuration of an electronic device according to a sixth embodiment.

FIG. 25 is a view illustrating a refresh rate and a frame rate.

FIG. 26 is a view illustrating a schematic configuration of an electronic device according to a seventh embodiment.

FIG. 27 is a view illustrating a schematic configuration of an electronic device according to an eighth embodiment.

FIG. 28 is a view illustrating another configuration of the electronic device of the eighth embodiment.

FIG. 29 is a perspective view illustrating a mobile phone that is of an example of the electronic device according to an embodiment of the present invention when the mobile phone is viewed from a front direction.

FIG. 30 is a perspective plan view illustrating a hinge 101 in FIG. 29 and a peripheral portion thereof.

FIG. 31 is a perspective view illustrating the mobile phone in FIG. 29 when the mobile phone is viewed from a backside direction.

### DESCRIPTION OF EMBODIMENTS OF THE INVENTION

Hereinafter, embodiments of the present invention will be described in detail with reference to the drawings. In the drawings, the identical or equivalent component is designated by the identical numeral, and the overlapping description is omitted.

### First Embodiment

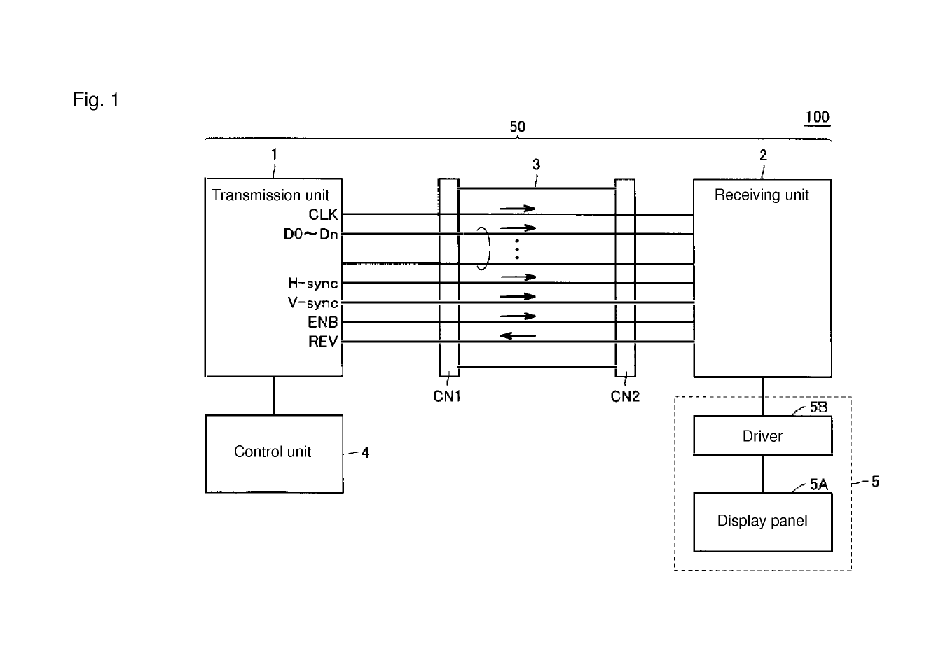

FIG. 1 is a block diagram illustrating a schematic configuration of an electronic device including an image data transmission system according to an embodiment of the present invention. Referring to FIG. 1, an electronic device 100 includes a data transmission system 50. The data transmission system 50 includes a transmission unit 1, a receiving unit 2, and a wiring unit 3.

The transmission unit 1 transmits an image data signal and a control signal to the receiving unit 2 through the wiring unit 3. For example, a control unit 4 generates the image data signal and the control signal, which are transmitted by the transmission unit 1. For example, the control unit 4 is constructed by an MPU (Micro Processing Unit). In the first embodiment, an electric signal is transmitted between the transmission unit 1 and the receiving unit 2 through the wiring unit 3. The wiring unit 3 includes a connector CN1 connected to a board (not illustrated) on which the transmission unit 1 is mounted and a connector CN2 connected to a board (not illustrated) on which the receiving unit 2 is mounted.

The receiving unit 2 receives the image data signal and the control signal, which are transmitted from the transmission unit 1, and transfers the image data signal and the control signal to a display device 5. The display device 5 receives the image data signal and the control signal from the receiving unit 2, and displays an image based on the image data signal and the control signal.

The display device 5 includes a display panel 5A that displays the image and a driver 5B that drives the display panel 5A. In an embodiment of the present invention, the display device 5 is a liquid crystal display device and the display panel 5A is a liquid crystal display panel. Although FIG. 1 illustrates the configuration in which the receiving unit 2 and the driver 5B are separated from each other, the receiving unit 2 and the driver 53 may integrally be provided. In other embodiments, the same configuration may be adopted.

The image data signal transmitted by the transmission unit 1 includes a clock signal CLK and data signals D0 to Dn. The clock signal CLK is used in image display processing performed by the display device 5. The data signals D0 to Dn are generated plural times by dividing a one-frame image in each line. The transmission unit 1 transmits the data signals D0 to Dn plural times during a predetermined transmission period during which the one-frame image is transmitted. “The predetermined transmission period during which the one-frame image is transmitted” is defined as an inverse number of a frame rate. The frame rate is an index expressing the number of frequencies of updating a screen per unit time, and the unit is fps (frame per second). In an embodiment of the present invention, there is no particular limitation to the frame rate. For example, the frame rate is set to 60 (fps). At the frame rate of 60 fps, the predetermined transmission period during which the one-frame image is transmitted becomes about 16.7 (msec).

The control signal transmitted from the transmission unit 1 includes a horizontal synchronous signal H-sync, a vertical synchronous signal V-sync, and a data enable signal ENB. The horizontal synchronous signal H-sync prescribes one horizontal scanning period and the vertical synchronous signal V-sync prescribes one vertical scanning period. The data enable signal ENB indicates that the data signals D0 to Dn transmitted from the transmission unit 1 are valid.

The transmission unit 1 accepts a signal REV, which is transmitted from display device 5, through the receiving unit 2 and the wiring unit 3. For example, the signal REV includes information indicating whether frame data is normally transmitted and information on a display specification of the display panel 5A.

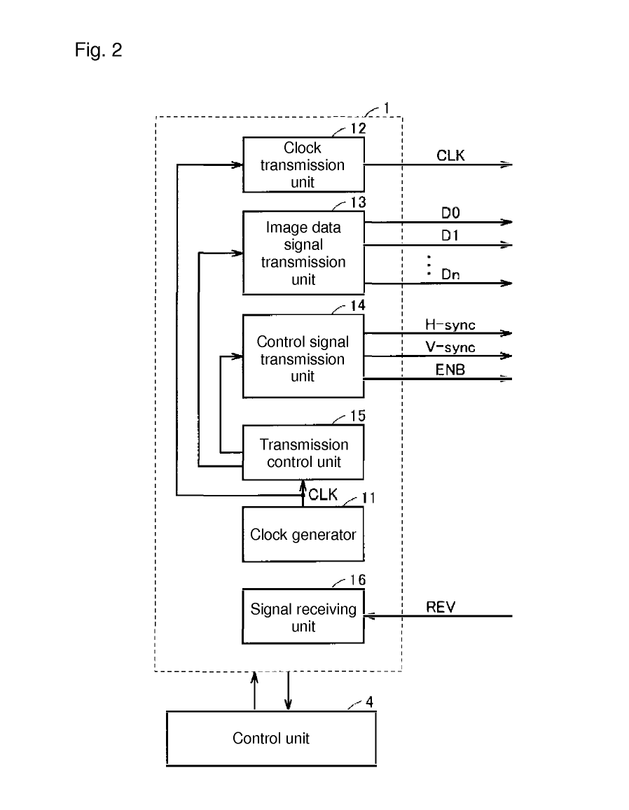

FIG. 2 is a functional block diagram of the transmission unit 1 in FIG. 1. Referring to FIG. 2, the transmission unit 1 includes a dock generator 11, a dock transmission unit 12, an image data signal transmission unit 13, a control signal transmission unit 14, a transmission control unit 15, and a signal receiving unit 16.

The clock generator 11 generates the clock signal CLK. The clock signal CLK is transferred to the clock transmission unit 12 and the transmission control unit 15. The clock transmission unit 12 outputs the clock signal CLK.

The image data signal transmission unit 13 transmits the data signals D0, D1, - - - , Dn according to transmission timing prescribed by the transmission control unit 15. The data signals D0, D1, - - - , Dn are collectively output from the image data signal transmission unit 13. The image data signal transmission unit 13 sequentially transmits plural image data signals (the image data signals correspond to the data signals D0, D1, - - - , Dn, respectively), which are generated by dividing the one-frame image, in a one-frame transmission period.

The control signal transmission unit 14 transmits the horizontal synchronous signal H-sync, the vertical synchronous signal V-sync, and the data enable signal ENB according to the transmission timing prescribed by the transmission control unit 15.

The transmission control unit 15 controls the image data signal transmission unit 13 and the control signal transmission unit 14 according to the clock signal CLK. Specifically, the transmission control unit 15 controls the image data signal transmission unit 13 such that the image data signal is transmitted from the image data signal transmission unit 13 in timing defined by the clock signal. Similarly the transmission control unit 15 controls the control signal transmission unit 14 such that the control signal is transmitted from the control signal transmission unit 14 in the timing defined by the clock signal.

Specifically, the transmission control unit 15 controls the image data signal transmission unit 13 and the control signal transmission unit 14 such that the control signal transmission unit 14 stops the transmission of the control signal when the image data signal transmission unit 13 transmits the data signals D0 to Dn. On the other hand, the transmission control unit 15 controls the image data signal transmission unit 13 and the control signal transmission unit 14 such that the control signal transmission unit 14 sends the control signal when the image data signal transmission unit 13 stops the transmission the data signals D0 to Dn. Therefore, the data signals D0 to Dn and the horizontal synchronous signal are alternately output during a data signal transmission period included in the one-frame transmission period.

The signal receiving unit 16 receives the signal REV. The signal REV is transmitted from the signal receiving unit 16 to the control unit 4.

As illustrated in FIGS. 1 and 2, the data transmission system 50 includes the transmission unit 1, the receiving unit 2, and the wiring unit 3. The transmission unit 1 sequentially outputs the plural data signals, which are generated by dividing the one-frame image in given units, and also outputs the control signal in order to control timing at which predetermined processing is performed based on each data signal (D0 to Dn). The receiving unit 2 receives the data signal and the control signal. The wiring unit 3 transmits the data signal and the control signal, which are received from the transmission unit 1, to the receiving unit 2.

The transmission unit sequentially outputs the plural data signals within a predetermined transmission period during which the one-frame image is transmitted. On the other hand, in the predetermined transmission period, the transmission unit 1 outputs the control signal in a first period during which the data signal is not output. The first period is a period that is equal to a sum of the transmission time of the given units which does not include the data signal in the predetermined transmission period. In the first embodiment, the first period corresponds to a sleep mode period of the transmission unit 1. The sleep mode period is set such that a ratio of the sleep mode period to the predetermined transmission period is larger than a ratio of the sum of a control-signal transmission period and a margin period for the transmission of the control signal to the predetermined transmission period.

In order to display the image on the screen of the display device 5, the image from an upper left corner of the screen to a lower right corner of the screen is drawn one-line by one-line. When the image is drawn from the uppermost line of the screen to the lowermost line of the screen, the image is drawn from the uppermost line of the screen again. Transmission processing, which is performed by the transmission unit 1 in order to perform the display processing of the display device 5, will be described below.

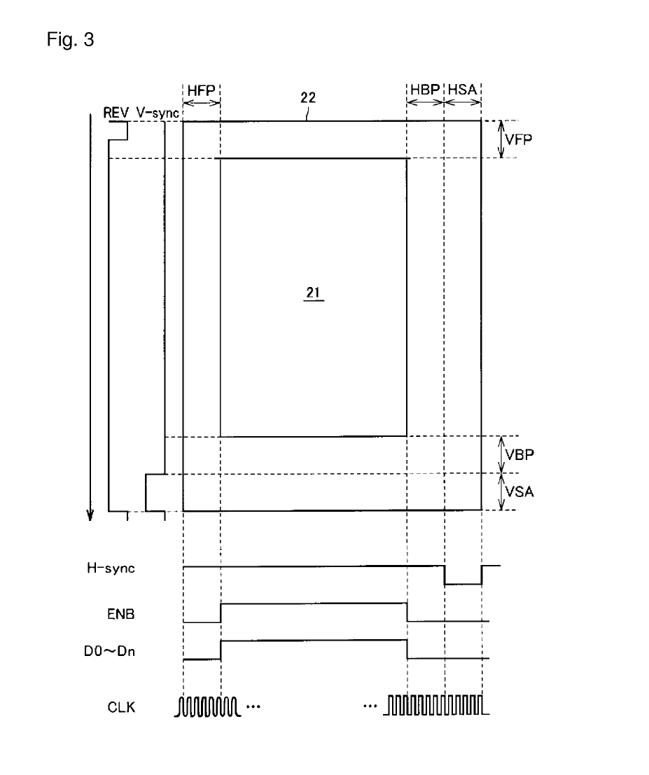

FIG. 3 is a view illustrating a horizontal blanking period and a vertical blanking period. Referring to FIG. 3, the horizontal synchronous signal H-sync prescribes one horizontal scanning period. The vertical synchronous signal V-sync prescribes one vertical scanning period. A vertical scanning direction synchronous period (V-sync Active; VSA), a vertical front poach period (VFP), a vertical back poach period (VBP), a horizontal scanning direction synchronous period (H-sync Active; HSA), a horizontal front porch period (HFP), and a horizontal back porch period (HBP) are prescribed as illustrated in FIG. 3.

The VSA corresponds to a period during which the vertical synchronous signal V-sync is valid. In the first embodiment, it is defined that the vertical synchronous signal V-sync is valid when the vertical synchronous signal V-sync is located at an L (Low)-level. Alternatively, it may be defined that the vertical synchronous signal V-sync is valid when the vertical synchronous signal V-sync is located at an H (High)-level.

The VFP and VBP are set as the margin period for a deviation of the transmission timing of the vertical synchronous signal V-sync. The VFP corresponds to a period before the image is displayed on the screen, and the VBP corresponds to a period after the image is displayed on the screen. The vertical blanking period corresponds to the sum of the VSA, the VFP, and the VBP. It is assumed that an internal frame rate (that is, 1/(predetermined transmission period for transmission of one-frame image)) of image display devices, such as a display, varies at the level of about ±10%. Therefore, in the first embodiment, it is determined that the sum of the transmission period for the vertical synchronous signal V-sync and the margin period (VFP and VBP) for the transmission of the vertical synchronous signal V-sync is less than or equal to 20% of the predetermined transmission period for the transmission of the one-frame image. The same holds true for other embodiments.

On the other hand, the HSA corresponds to a period during which the horizontal synchronous signal H-sync is valid. Like the vertical synchronous signal V-sync, in the first embodiment, it is defined that the horizontal synchronous signal H-sync is valid when the horizontal synchronous signal H-sync is located at the L-level. Alternatively, it may be defined that the horizontal synchronous signal H-sync is valid when the horizontal synchronous signal H-sync is located at the H-level.

The HFP and HBP are set as the margin period for a deviation of the transmission timing of the horizontal synchronous signal H-sync. The HFP corresponds to a period before the image for one line is displayed on the screen, and the VBP corresponds to a period after the image for one line is displayed on the screen. The horizontal blanking period corresponds to the sum of the HSA, the HFP, and the HBP. It is assumed that a time lag between the horizontal synchronous signal and the image data signal is generated up to about ten times the transmission period of the horizontal synchronous signal. Therefore, in the first embodiment, it is defined that each of the HFP and HBP is the period less than or equal to ten times the transmission period of the horizontal synchronous signal H-sync. The same holds true for other embodiments.

The period during which the data enable signal ENB is valid is the period during which the data signals D0 to Dn are valid. In the first embodiment, the data enable signal ENB is located at the H-level when the data enable signal ENB is valid. The period during which the data enable signal ENB is located at the H-level is a period (a horizontal display period) during which the image corresponding to one line is displayed.

The image corresponding to one frame is formed by displaying the images of all the lines. A period necessary to draw the image from the upper left of the screen to the lower right of the screen corresponds to a vertical display period. On the other hand, the image is not displayed in the horizontal blanking period and the vertical blanking period. The sum of the horizontal blanking period and the horizontal display period corresponds to one horizontal scanning period. The sum of the vertical blanking period and the vertical display period corresponds to one vertical scanning period.

A domain 21 is a domain expressing the period during which the image is displayed on the display panel 5A, and the domain 21 corresponds to a display domain. A domain 22 is a domain expressing the period during which the image is not displayed, and the domain 21 corresponds to a virtual display domain. The domain 21 is disposed in the domain 22.

In the first embodiment, the control is performed based on the clock signal in order to display the image on the screen. Specifically, the horizontal display period, namely, the period during which the data enable signal ENB is valid is an integral multiple of a clock signal cycle. Similarly, each of time widths of the VFP, the VBP, the VSA, the HFP, the HSA, and the HBP is an integral multiple of the clock signal cycle.

The transmission control unit 15 counts the clock signal CLK that is generated in a form of a pulse. The transmission control unit 15 controls the control signal transmission unit 14 based on the counted value, thereby controlling the timing at which the control signal transmission unit 14 transmits the control signal and the period during which the control signal is valid. The transmission control unit 15 controls the image data signal transmission unit 13 based on the counted value of the clock pulse. Therefore, the timing at which the image data signal transmission unit 13 transmits the data signal is determined.

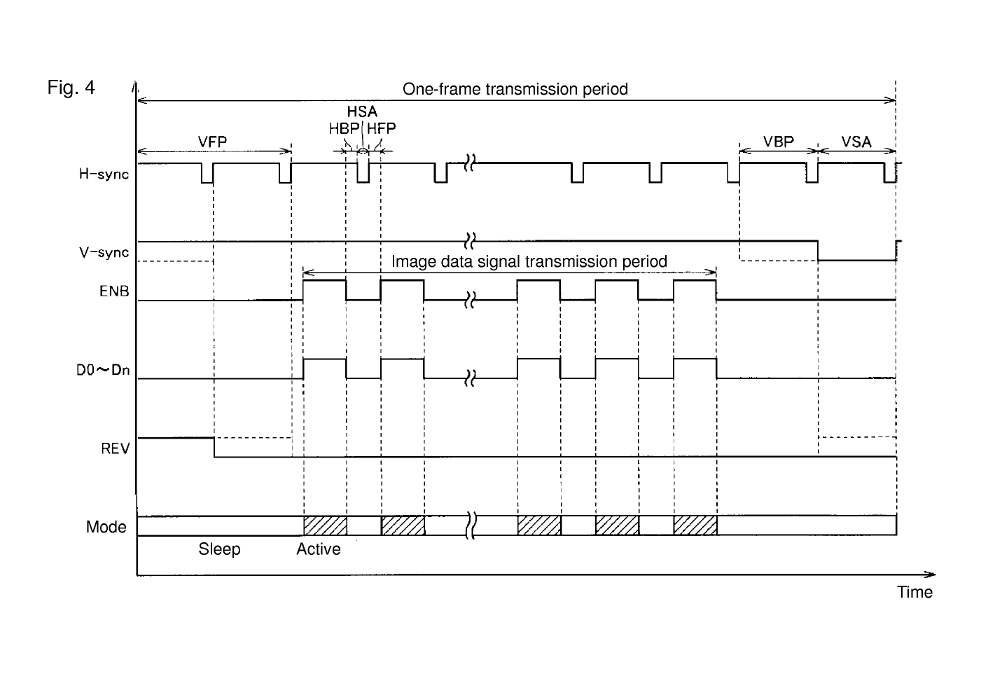

FIG. 4 is a timing chart illustrating an example of an operation of the transmission unit in order to perform the display processing in FIG. 3. The timing chart illustrates a basic operation of the transmission unit of an embodiment of the present invention.

Referring to FIGS. 3 and 4, the one-frame transmission period is previously determined from the frame rate. As described above, the period during which the horizontal synchronous signal H-sync, the vertical synchronous signal V-sync, the data enable signal ENB are valid, and the timing at which each of these signals is transmitted (the signal cycle) are controlled by the clock signal CLK. However, for the sake of convenience, the clock signal CLK is not illustrated in FIG. 4.

The VSA is the period during which the vertical synchronous signal V-sync is valid, namely, the period during which the vertical synchronous signal V-sync is located at the L-level.

The VFP and VBP are provided as the margin period for the transmission of the vertical synchronous signal V-sync. The VBP is set as the period immediately, before the VSA, and the VFP is set as the period immediately after the VSA.

The HSA is the period during which the horizontal synchronous signal H-sync is valid, namely, the period during which the horizontal synchronous signal H-sync is located at the L-level. The HBP is set as the period before the HSA. On the other hand, the HFP is set as the period after the HSA. As can be seen from FIG. 3, this means that pixels are sequentially displayed from a left end of one line to a right end when the image corresponding to the one line is drawn on the screen. As described above, the HFP and HBP are provided as the margin period for the transmission of the horizontal synchronous signal H-sync.

When the HFP is ended, the data enable signal ENB becomes valid. That is, the data enable signal ENB becomes the H-level. When the data enable signal ENB becomes valid, the data signals D0 to Dn are transmitted from the transmission unit 1. On the other hand, when the data enable signal ENB becomes invalid, the transmission of the data signals D0 to Dn is stopped. The timing at which the data enable signal ENB becomes invalid means the timing at which the data enable signal ENB is switched from the H-level to the L-level. Specifically, the data enable signal ENB becomes invalid at the beginning of the HBP.

The data signals D0 to Dn corresponds to the one-line image. During the one-frame transmission period, the data enable signal ENB repeatedly becomes valid according to the number of frequencies of transmitting the data signals D0 to Dn. Therefore, the data signals D0 to Dn are transmitted plural times during the one-frame transmission period.

An image data signal transmission period is started after the VFP ends and then started via the HFP. The image data signal transmission period is determined based on the cycle of the data enable signal ENB and the number of frequencies (the number of frequencies of transmitting the data signals D0 to Dn) at each of which the data enable signal ENB becomes valid in the one-frame transmission period. The image data signal transmission period is started when the HFP elapses and then the VFP ends.

The signal REV is transmitted from the display device 5 to the transmission unit 1 in the vertical blanking period.

An operating mode of the trans fission nit 1 is switched between an active mode and a sleep mode. The active mode is a mode in which the data signals D0 to Dn are transmitted. A data size of the data signals D0 to Dn is larger than a data size of the control signal. Therefore, power consumption per unit time of the transmission unit 1 increases when the transmission unit 1 is in the active mode. On the other hand, in the sleep mode, the transmission unit 1 stops the transmission of the data signals D0 to Dn. In the first embodiment, a sleep mode period is a period equal to the first period, namely, a period equal to the sum of the transmission time of the given-units (one-line) which does not include the data signal in the transmission period previously determined as the one frame transmission period. The image data signal transmission period corresponds to a period from the beginning of the transmission of the initial data signal to the end of the transmission of the final data signal in the plural data signals. The power consumption per unit time of the transmission unit 1 in the sleep mode is smaller than the power consumption per unit time of the transmission unit 1 in the active mode.

The transmission of the data signals D0 to Dn is stopped in the sleep mode as described above, so that an increase in average power consumption of the transmission unit 1 can be prevented in the one-frame transmission period. However, in the timing chart in FIG. 4, the blanking period includes the period (VSA and HSA) during which the control signal is transmitted and the margin period (VFP, VBP, HFP, and HBP) for the transmission of the control signal. Accordingly, a ratio of the blanking period to the one-frame transmission period is small. Therefore, an effect to reduce the power consumption is insufficiently obtained. In an embodiment of the present invention, the ratio of the sleep mode period to the one-frame transmission period is increased. The average power consumption of the transmission unit 1 can be reduced in the one-frame transmission period by increasing the ratio of the sleep mode period to the one-frame transmission period.

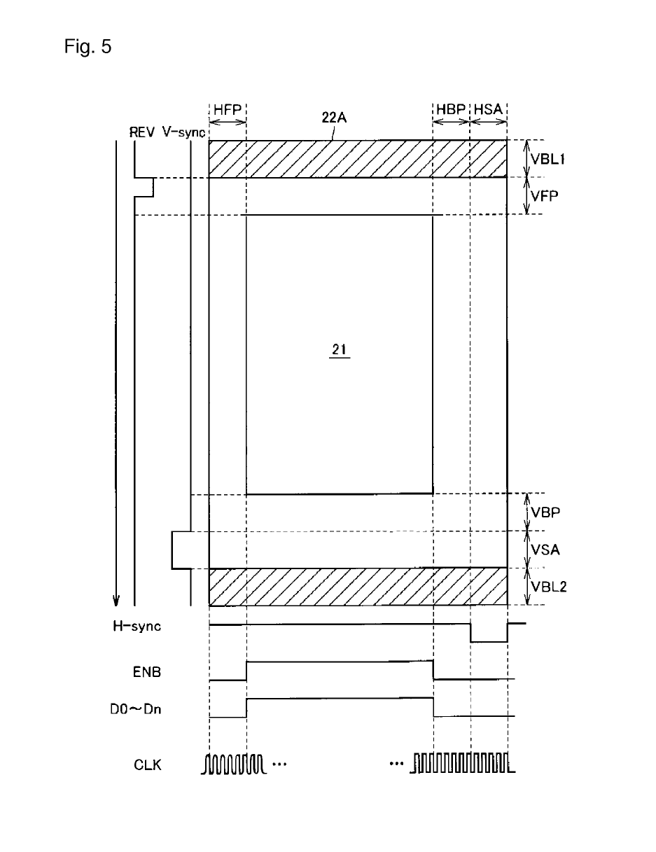

A vertical blanking period is added in the first embodiment. FIG. 5 is a view illustrating the vertical blanking period added by the transmission unit of the first embodiment. Referring to FIGS. 3 and 5, a domain 22A differs from the domain 22 in that the domain 22A includes domains corresponding to vertical blanking periods VBL1 and VBL2. The domain corresponding to the vertical blanking period VBL1 is located immediately above the domain corresponding to the vertical front porch VFP. On the other hand, the domain corresponding to the vertical blanking period VBL2 is located immediately, below the domain corresponding to the vertical scanning direction synchronous period VSA.

There is no particular limitation of the number of lines (the horizontal scanning period) corresponding to each of the vertical blanking periods VBL1 and VBL2, but at least one line may correspond to each of the vertical blanking periods VBL1 and VBL2. The vertical blanking periods VBL1 and VBL2 are not limited to settings (domain dispositions corresponding to the vertical blanking periods VBL1 and VBL2) in FIG. 5. The domains corresponding to the vertical blanking periods VBL1 and VBL2 can be disposed at any position in the vertical direction of the domain 22A. That is, the vertical blanking period can be added in arbitrary timing in the one-frame transmission period.

Both the vertical blanking periods VBL1 and VBL2 are not necessarily set. As described above, the vertical blanking period corresponding to at least one horizontal scanning period may newly be added in the timing chart in FIG. 4. That is, in the first embodiment, assuming that N is integers of 1 or more, the vertical blanking period corresponding to N lines (a period N times one horizontal scanning period) is set in arbitrary timing in the one-frame transmission period.

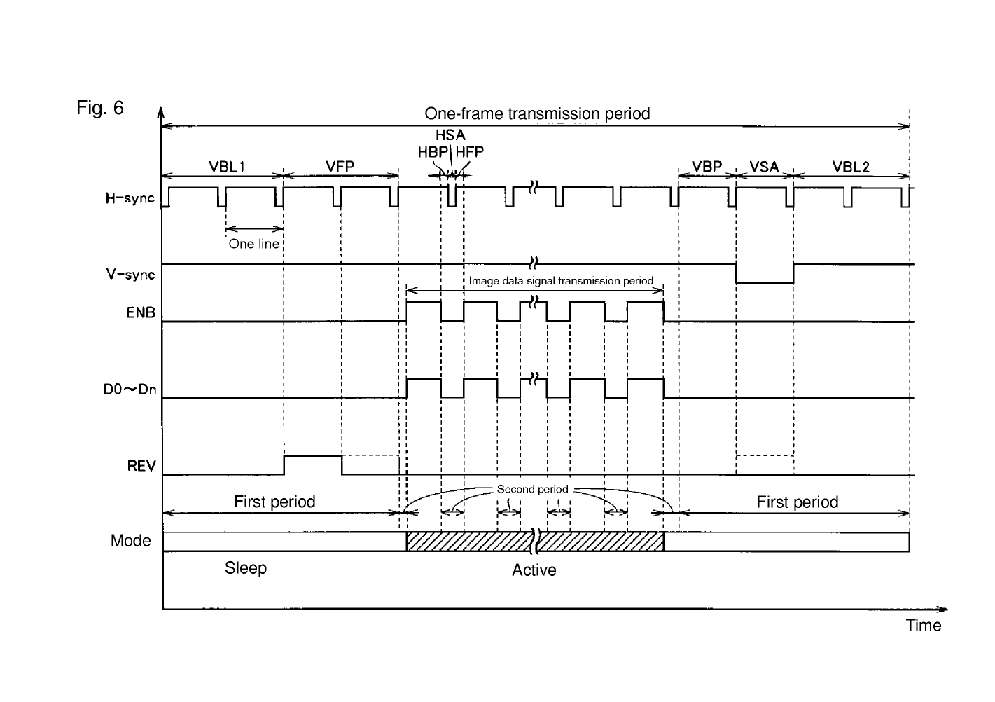

FIG. 6 is a timing chart illustrating an operation of the transmission unit 1 of the first embodiment. Referring to FIGS. 4 and 6, the VBL1 is set as the period immediately before the VFP. The VBL2 is set as the period immediately after the VSA. This corresponds to the settings of the vertical blanking periods VBL1 and VBL2 in FIG. 5.

In the first embodiment, the sleep mode period is larger than VFP+VBP+VSA because of the addition of the vertical blanking periods VBL1 and VBL2 during which both the control signal (vertical synchronous signal V-sync) and the data signal are not transmitted. In the first embodiment, the blanking period (VBL1 and VBL2) defined as “predetermined transmission period for transmission of one-frame image”−“image data signal transmission period”−“control signal transmission period”−“margin period” is added to the sleep mode period. Therefore, a relationship expressed by the following expression (1) is satisfied in the first embodiment,

(Sleep mode period included in one-frame transmission period/one-frame transmission period)>(sum of control signal transmission period and margin period for transmission of control signal/one frame transmission period) (1)

Referring to FIGS. 5 and 6, the one line corresponds to each of the given units into which the one-frame image is divided. The one-frame transmission period can be defined by a product of the number of given units (lines) and the given-unit transmission period. Some given units included in the one frame transmission period include the data signal; some given units do not include the data signal. The sum of the transmission periods in the “given units” that do not include the data signals corresponds to the “sleep mode period” (the first period). On the other hand, the second period is the sum of time difference obtained by subtracting the data signal transmission period from the transmission period of the “given unit” that includes the data signal in the one-frame transmission period. The first period corresponds to VBL1+VFP+VBP+VSA+VBL2. On the other hand, the second period includes the period of the sum of (HBP+HSA+HFP) in the image data signal transmission period, the period from the end of the VFP to the beginning of the image data signal transmission period, and the period from the end of the image data signal transmission period to the beginning of the VBP.

In the timing chart in FIG. 6, the whole image data signal transmission period is defined as the period corresponding to the active mode of the transmission unit 1. Alternatively, like the timing chart in FIG. 4, only the period during which the data enable signal ENB is valid may be defined as the active mode period. That is, the active mode period may intermittently (discontinuously) be generated in the one-frame transmission period.

In the case that the vertical blanking period is simply added to the timing chart in FIG. 4, the one-frame transmission period becomes longer than the original transmission period. The lengthening of the one-frame transmission period means the decrease in frame rate. When the frame rate decreases, it is difficult to the smoothly display the image. In the first embodiment, the cycle of the clock signal CLK is shortened by enhancing a dock frequency. Therefore, the lengthening of the one frame transmission period can be prevented.

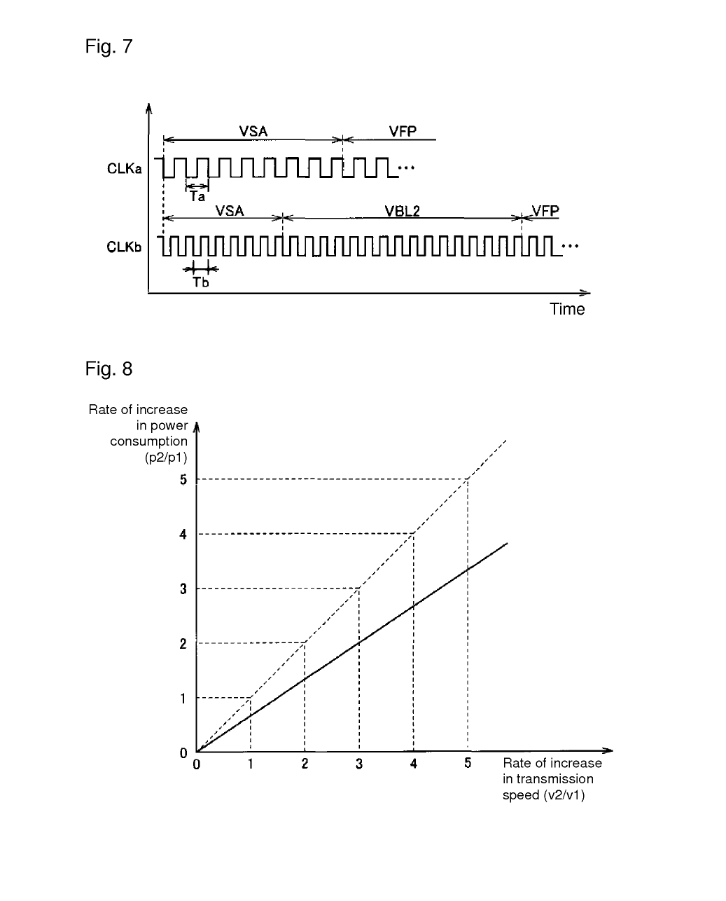

FIG. 7 is a view illustrating the dock signal CLK prescribing the signal transmission performed by the transmission unit 1 of the first embodiment. Referring to FIG. 7, a dock signal CLKa indicates the dock signal used in the processing of the timing chart in FIG. 4. A dock signal CLKb indicates the dock signal used in the processing of the first embodiment, namely, the processing of the timing chart in FIG. 6. A cycle Ta of the dock signal CLKa is longer than a cycle Tb of the dock signal CLKb. In other words, a frequency of the dock signal CLKb is higher than a wave number of the dock signal CLKa.

The transmission control unit 15 counts the dock pulse, and controls the timing at which the image data signal transmission unit 13 transmits the image data signal, and the timing at which the control signal transmission unit 14 transmits the control signal based on the number of counts (the number of pulses). Therefore, even if the frequency of the clock signal changes, the processing performed by the transmission control unit 15 does not change basically. Accordingly, the lengths of the VSA, VFP, and the like are simply inversely proportional to the frequency of the clock signal. The VSA and the VFP are shortened by enhancing the frequency of the clock signal. Therefore, the vertical blanking period (VBL1 and VBL2) can be added without changing the one-frame transmission period. Therefore, the ratio of the sleep mode period to the one frame transmission period can be enhanced.

According to the first embodiment, the image data signal transmission period is shortened because the vertical blanking period is added without changing the one-frame transmission period. Therefore, it is necessary that the image data signal transmission unit 13 enhance a data signal transmission speed. However, when the transmission speed is enhanced, the power consumption of the transmission unit 1 (particularly, the power consumption of the image data signal transmission unit 13) increased in the image data signal transmission period. Therefore, there is a possibility of decreasing the effect to reduce the power consumption of the transmission unit 1 in the one-frame transmission period.

FIG. 8 is a view illustrating a relationship between an increasing amount of an image data transmission speed and an increasing amount of the power consumption of the transmission unit 1. Referring to a graph in FIG. 8, a horizontal axis indicates a rate of increase in transmission speed (a ratio of a second transmission speed v2 to a first transmission speed v1), and a vertical axis indicates a rate of increase in power consumption (p2/p1) of the transmission unit 1. Power consumption p1 is a power consumption of the transmission unit 1 at the first transmission speed v1, and power consumption p2 is a power consumption of the transmission unit 1 at the second transmission speed v1. As illustrated in FIG. 8, the rate of increase in power consumption is proportional to the rate of increase in transmission speed.

A broken-line gradient is 1, and the rate of increase in power consumption is equal to the rate of increase in transmission speed. As indicated by the broken line, when the power consumption increases, there is a possibility of weakening the effect of reducing the average power consumption of the transmission unit in the one-frame transmission period even if the ratio of the sleep mode period to the one-frame transmission period increases.

On the other hand, a solid-line gradient is smaller than the broken-line gradient (that is, 1). In this case, the increase in power consumption of the transmission unit 1 is controlled even if the transmission speed is changed from the first speed to the second speed. Therefore, the ratio of the sleep mode period to the one-frame transmission period is increased to enhance the effect of reducing the average power consumption of the transmission unit in the one-frame transmission period. Accordingly, the effect of reducing the power consumption of the transmission system is further enhanced. In an embodiment of the present invention, the transmission speed of the transmission unit 1 is set within a transmission speed range in which a relationship corresponding to the solid-line gradient in FIG. 8 is satisfied.

Preferably the relationship between the transmission speed and the power consumption, which is determined by the solid line in FIG. 8, is satisfied in transmission units according to the following embodiments. Therefore, the detailed description on the relationship in FIG. 8 is not repeated below.

In the above description, only the transmission mode in FIGS. 6 and 7 is illustrated as the transmission mode of the transmission unit 1 that transmits the image data signal. However, the transmission unit 1 is not limited to the single transmission mode (in the first embodiment, the transmission mode in FIGS. 6 and 7). Specifically, the transmission unit 1 may have both the transmission mode (first mode) in FIGS. 4 and 5 and the transmission mode (second mode) in FIGS. 6 and 7. In this case, the transmission unit 1 can switch between the first mode and the second mode according to a given condition, for example, the display mode of the display device 5 in FIG. 1. In the following embodiments, similarly the transmission unit can have the first transmission mode in FIGS. 4 and 5 and the second transmission mode whose the transmission speed is higher than that of the first transmission mode. However, in such cases, preferably the relationship between the transmission speed and the power consumption, which is determined by the solid line in FIG. 8, is satisfied as described above.

According to the first embodiment, the sleep mode period is set such that the ratio of the sleep mode period to the one-frame transmission period is larger than the ratio of the sum of the control signal (vertical synchronous signal) transmission period and the margin period (VFP and VBP) for the transmission of the control signal to the one-frame transmission period. Therefore, the average power consumption of the transmission unit 1 is reduced in the one-frame transmission period. Accordingly, in the first embodiment, the power consumption of the transmission unit 1 can be reduced. According to the first embodiment, the power consumption of the display device 5 can also be reduced in the one-frame transmission period.

### Second Embodiment

A horizontal blanking period is added in a second embodiment. The second embodiment differs from the first embodiment in this point.

A configuration of an electronic device of the second embodiment is identical to the configuration of the electronic device 100 in FIG. 1. A configuration of a transmission unit of the second embodiment is identical to the configuration of the transmission unit 1 in FIG. 2. Accordingly, the configurations of the electronic device and the transmission unit of the second embodiment are not described in detail below.

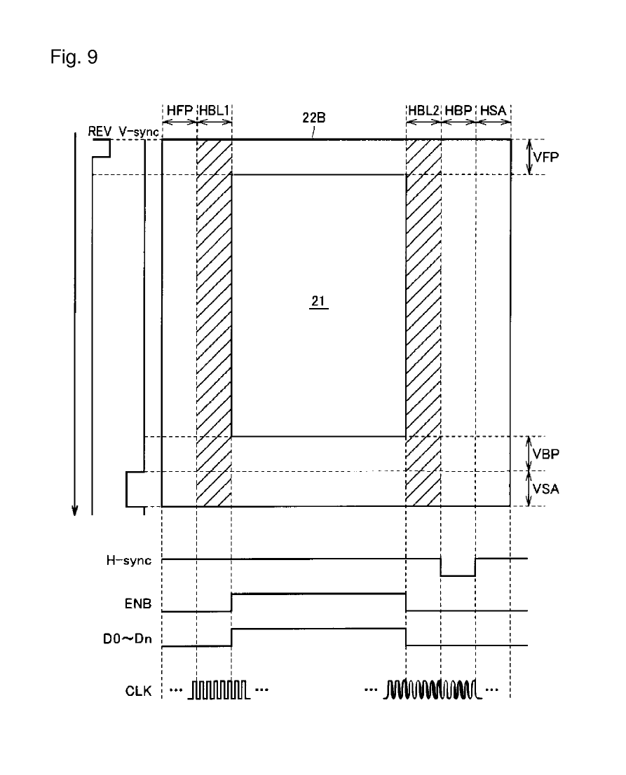

FIG. 9 is a view illustrating the horizontal blanking period added by the transmission unit of the second embodiment. Referring to FIGS. 3 and 9, a domain 22B differs from the domain 22 in that the domain 22B includes domains corresponding to horizontal blanking periods HBL1 and HBL2. The domain corresponding to the horizontal blanking period HBL1 is located between the domain corresponding to the horizontal front porch period HFP and the domain 21. The domain corresponding to the horizontal blanking period HBL2 is located between the domain 21 and the domain corresponding to the horizontal front porch period HFP.

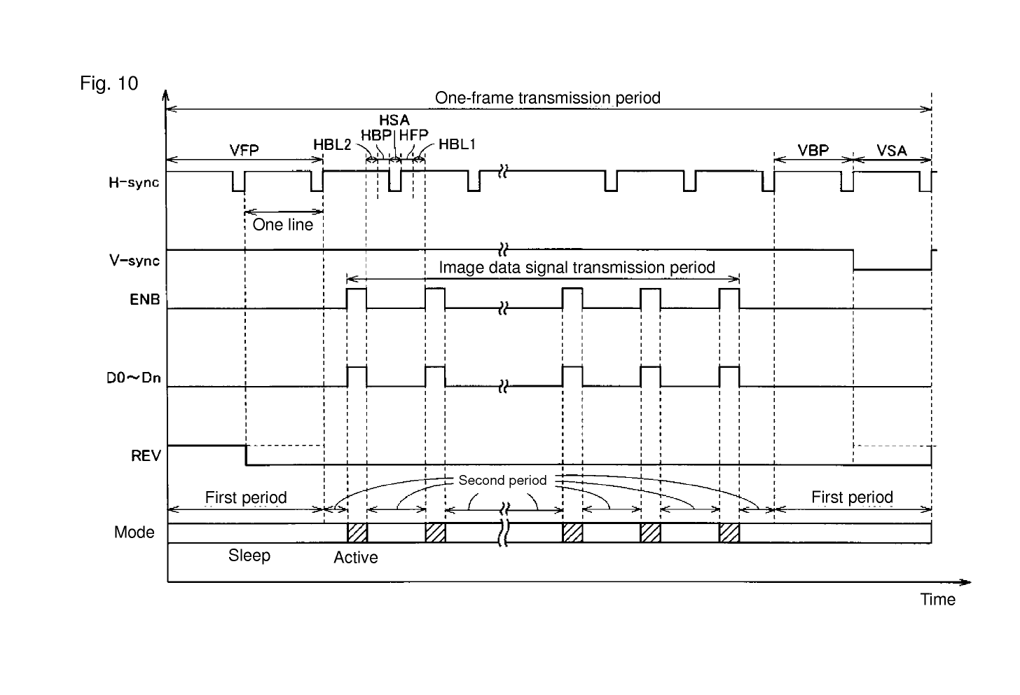

FIG. 10 is a timing chart illustrating an operation of the transmission unit 1 of the second embodiment. Referring to FIGS. 4 and 10, the HBL2 is set as the period immediately before the HBP. The HBL1 is set as the period immediately after the HFP. This corresponds to the settings of the horizontal blanking periods HBL1 and HBL2 in FIG. 9.

Referring to FIGS. 9 and 10, the first period is a period that is equal to the sum of given-unit transmission times, each of which does not include the data signal in the predetermined transmission period. Accordingly, in the second embodiment, the first period corresponds to VFP+VBP+VSA. The second period is a period that is equal to the sum of time difference obtained by subtracting the data signal transmission period from the given-unit transmission period including the data signal in the predetermined transmission period. Accordingly, in the second embodiment, the second period includes the period of the sum of (HBL2+HBP+HSA+HFP+HBL1) in the image data signal transmission period, the period from the end of the VFP to the beginning of the image data signal transmission period, and the period from the end of the image data signal transmission period to the beginning of the VBP. In the horizontal blanking periods HBL1 and HBL2, both the data signal and the control signal (horizontal synchronous signal H-sync) are not transmitted.

In the second embodiment, the second period is defined as the sleep mode period in the expression (1). In the second embodiment, the “control signal” in the expression (1) is set to the H-sync and the margin period in the expression (1) is set to the HFP and the HBP. Like the first embodiment, the relationship expressed by the expression (1) holds in the second embodiment.

In the second embodiment, the horizontal blanking periods HBL1 and HBL2 are inserted in each horizontal scanning period. Therefore, the ratio of the sleep mode period to the one-frame transmission period is increased such that the relationship expressed by the expression (1) is satisfied, so that the average power consumption of the transmission unit 1 can be reduced in the one-frame transmission period. Like the first embodiment, in the second embodiment, the dock frequency is enhanced, which allows the horizontal blanking periods HBL1 and HBL2 to be set without lengthening the one-frame transmission period (without decreasing the frame rate).

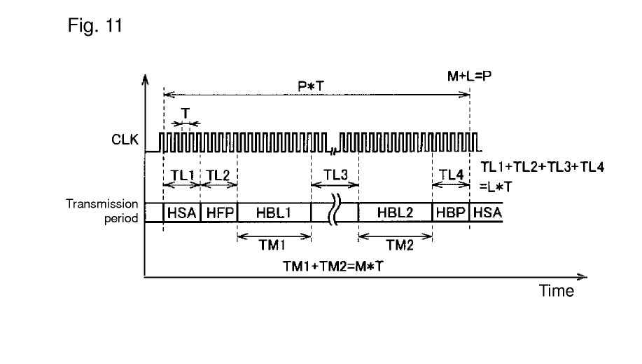

FIG. 11 is a view illustrating a relationship between the one-line transmission period (the horizontal scanning period) and the horizontal blanking periods HBL1 and HBL2. Referring to FIG. 11, T designates a dock cycle (the cycle of the dock signal CLK). It is assumed that TM1 and TM2 are lengths of the HBL1 and the HBL2, respectively. On the other hand, it is assumed that TL1, TL2, TL3, and TL4 are lengths of the HSA, the HFP, the image data signal transmission period, and the NBP. Assuming that M is a cycle number (an integer), the margin period (the horizontal blanking periods HBL1 and HBL2) is expressed by TM1+TM2=M*T. On the other hand, TL1+TL2+TL3+TL4 is expressed by L*T. L is an integer. Assuming that P is a cycle number (an integer), the one-line transmission period (one horizontal scanning period) is expressed by P*T. A relationship of P=M+L holds among P, L, and M.

That is, the one-line transmission period and the horizontal blanking period HBL1 (HBL2) are integral multiples of the clock cycle number. Therefore, the horizontal blanking period can be provided in arbitrary timing in the one-line transmission period.

As described above, according to the second embodiment, the power consumption of the transmission unit 1 can be reduced like the first embodiment. According to the second embodiment, the power consumption of the display device 5 can also be reduced in the one-frame transmission period.

### Third Embodiment

In a third embodiment, the image is displayed in the domain on part of the display screen. The third embodiment differs from the first and the second embodiments in this point. A configuration of an electronic device of the third embodiment is identical to the configuration of the electronic device 100 in FIG. 1. A configuration of a transmission unit of the third embodiment is identical to the configuration of the transmission unit 1 in FIG. 2. Accordingly, the configurations of the electronic device and the transmission unit of the third embodiment are not described in detail below.

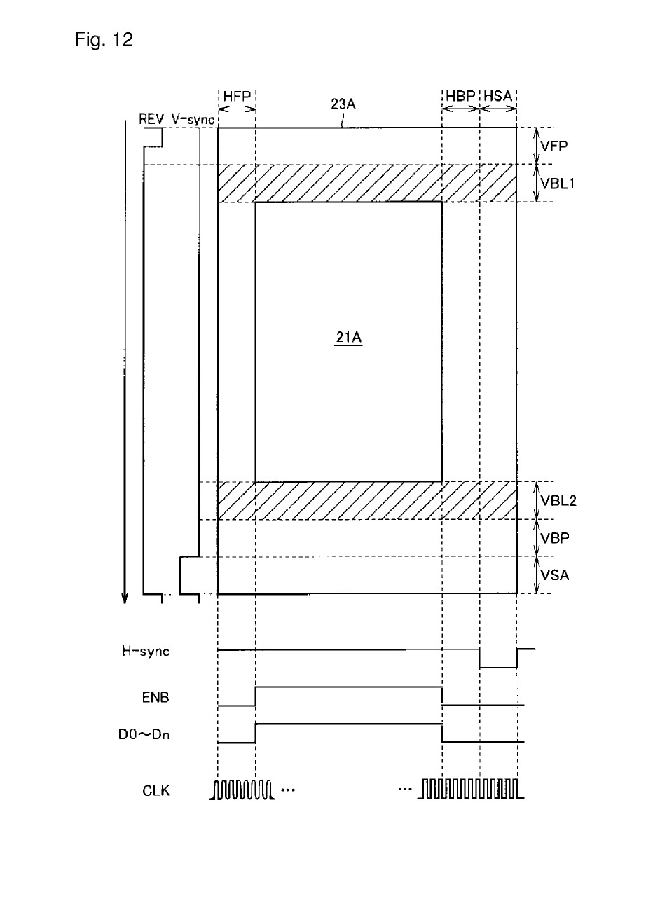

FIG. 12 is a first view illustrating a blanking period added by the transmission unit of the third embodiment. Referring to FIGS. 3 and 12, a domain 23A differs from the domain 22 in that dispositions of domains corresponding to vertical blanking periods VBL1 and VBL2. Specifically, in the domain 23A, the domain corresponding to the vertical blanking period VBL1 is disposed below the domain corresponding to the VFP, and the domain corresponding to the vertical blanking period VBL2 is disposed above the domain corresponding to the VBP. As a result, in a domain 21A, the domain 21 in FIG. 3 is vertically contracted. The domain 21A indicates that the display domain in the screen is vertically contracted.

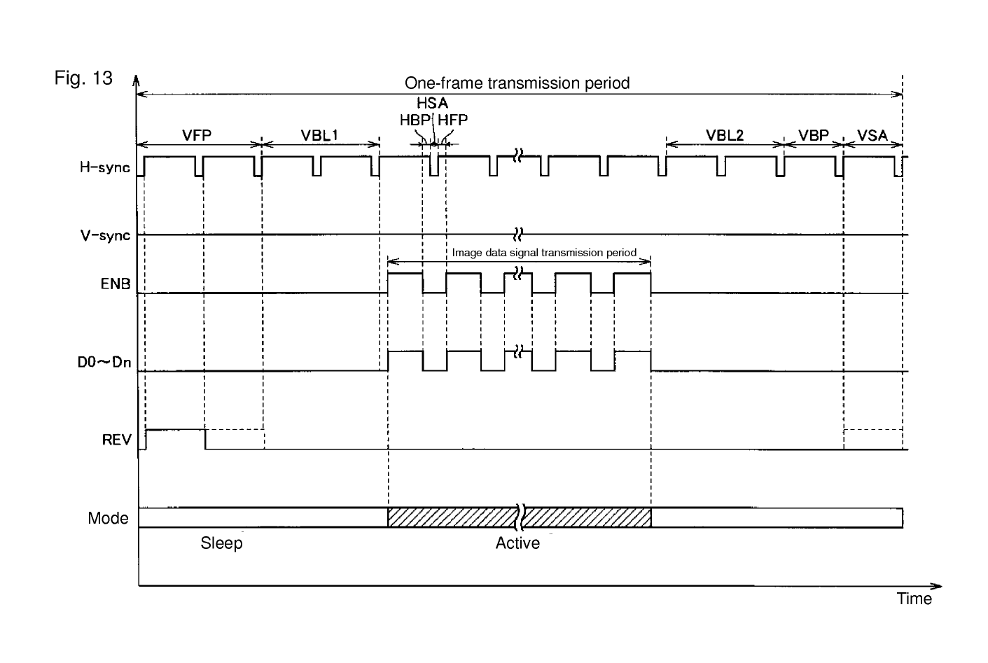

FIG. 13 is a timing chart illustrating display processing in FIG. 12. Referring to FIG. 13, the period immediately after the VFP is set as the VBL1. The period immediately before the VBP is set as the VBL2. This corresponds to the settings of the vertical blanking periods VBL1 and VBL2 in FIG. 12.

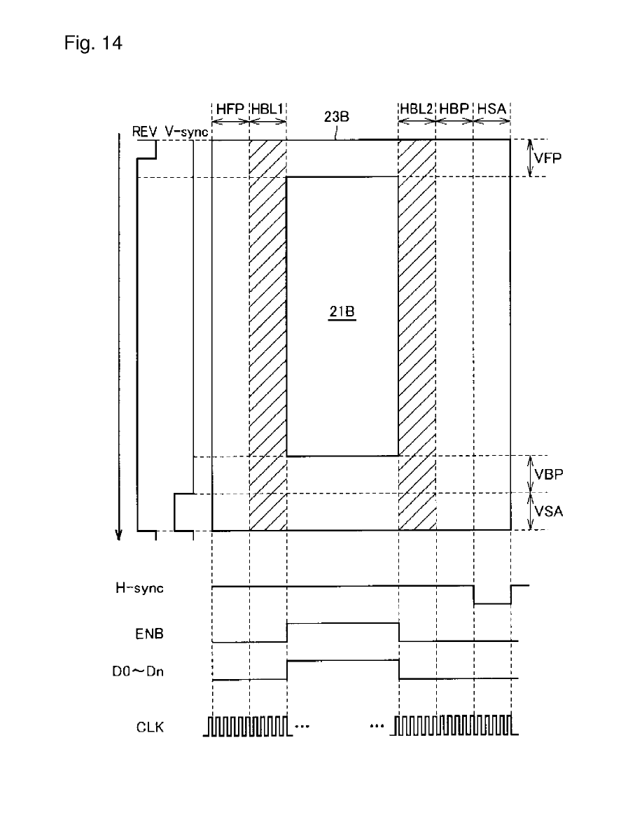

FIG. 14 is a second view illustrating the blanking period added by the transmission unit of the third embodiment. Referring to FIGS. 9 and 14, a domain 21B corresponds to the domain in which the domain 21 is horizontally contracted. The domain 21B indicates that the display domain in the screen is horizontally contracted.

The third embodiment is identical to the second embodiment in the disposition of the domain corresponding to each of the horizontal blanking periods HBL1 and HBL2. Therefore, the timing chart illustrating the display processing in FIG. 14 is substantially identical to the timing chart in FIG. 10.

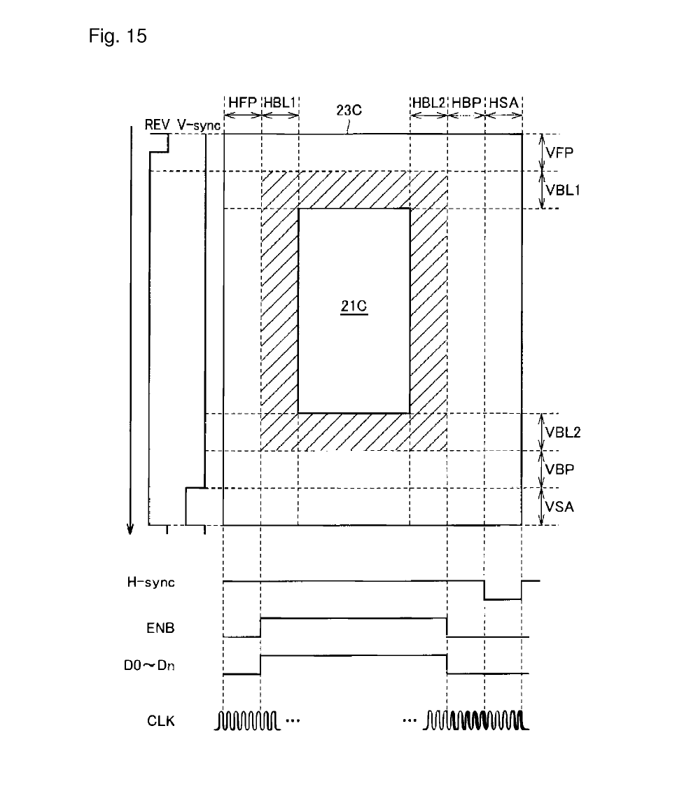

FIG. 15 is a third view illustrating the blanking period added by the transmission unit of the third embodiment. Referring to FIG. 15, the domains corresponding to the vertical blanking periods VBL1 and VBL2 and the domains corresponding to the horizontal blanking periods HBL1 and HBL2 are added. A domain 210 corresponds to the domain in which the domain 21 in FIG. 3 is horizontally and vertically contracted. The display processing in FIG. 15 corresponds to processing in which the display processing in FIG. 12 and the display processing in FIG. 14 are combined.

In this case, the sleep mode period in the expression (1) includes the first period and the second period. In the third embodiment, the “control signal” in the expression (1) is set to the horizontal synchronous signal H-sync and the vertical synchronous signal V-sync, and the margin period in the expression (1) is set to the HFP, the HBP, the VFP and the VBP. Like the first and second embodiments, the relationship expressed by the expression (1) holds in the third embodiment.

As described above, in the third embodiment, the image is displayed in the domain on part of the display screen. That is, in the third embodiment, the actual display domain is contracted in at least one of the horizontal and vertical directions. Therefore, because at least one of the horizontal blanking period and the vertical blanking period can be provided, the average power consumption of the transmission unit can be reduced in the one-frame transmission period. The power consumption of the display device 5 can also be reduced in the one-frame transmission period.

In the case that the size of the domain 210 is equal to the size of the domain 21, the display processing corresponds to the processing in which the processing of the first embodiment (see FIG. 5) and the processing of the second embodiment (see FIG. 9) are combined. That is, even if the image is displayed on the normal-size screen, both the horizontal blanking period and the vertical blanking period can be added into the one-frame transmission period by the combination of the processing of the first embodiment and the processing of the second embodiment.

### Fourth Embodiment

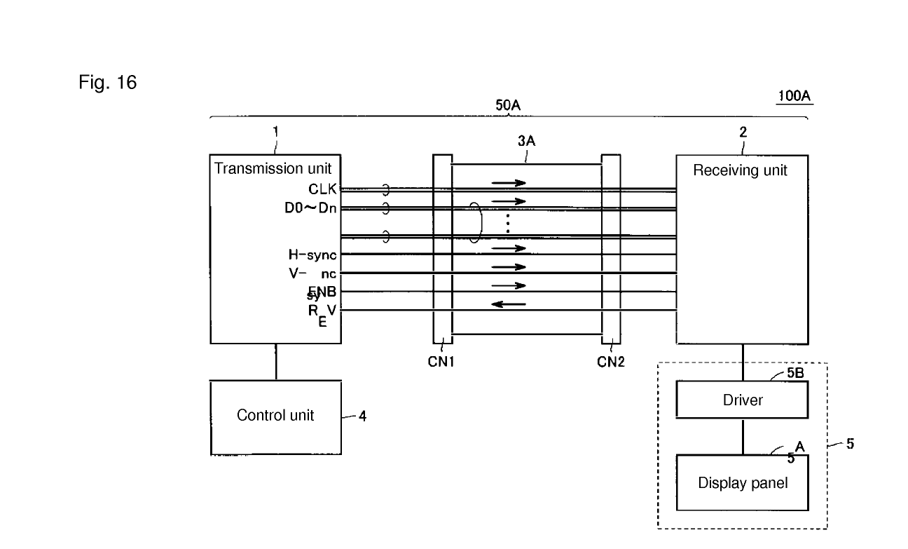

FIG. 16 is a view illustrating a schematic configuration of an electronic device including a transmission system according to a fourth embodiment. Referring to FIGS. 1 and 16, an electronic device 100A differs from the electronic device 100 in that the electronic device 100A includes a data transmission system 50A instead of the data transmission system 50. The data transmission system 50A differs from the data transmission system 50 in that the data transmission system 50A includes a wiring unit 3A instead of the wiring unit 3.

The wiring unit 3A includes a differential serial interface. In the fourth embodiment, a differential transmission line through which the clock signal CLK is transmitted and (n+1) differential transmission lines corresponding to the data signals D0 to Dn are provided in the wiring unit 3A.

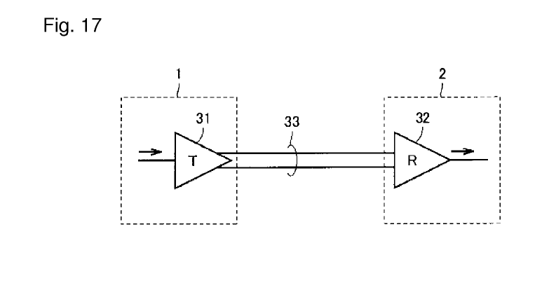

FIG. 17 is a view illustrating a configuration example of a differential serial interface circuit. Referring to FIG. 17, the transmission unit 1 includes a transmitter 31. The receiving unit 2 includes a receiver 32. The transmitter 31 and the receiver are connected to each other by a differential transmission line 33. The transmitter 31 converts the signal (each of the clock signal CLK and data signals D0 to Dn) that should be transmitted into a differential signal, and outputs the differential signal to the differential transmission line 33. The receiver 32 receives the differential signal through the differential transmission line 33, and restores the signal, which should be transmitted by the transmitter 31, based on the differential signal.

The differential transmission has features, such as high-speed data transmission and high noise resistance. A differential serial transmission method is adopted in the transmission of the data signals D0 to Dn, so that the data signals D0 to Dn can be transmitted at a high speed.

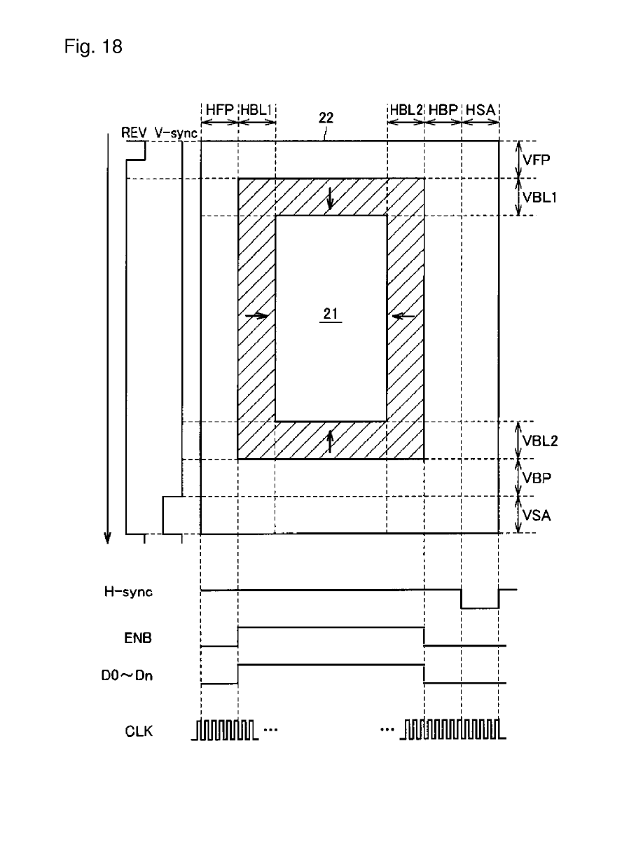

FIG. 18 is a view illustrating an effect of the differential serial interface circuit. Referring to FIG. 18, the differential serial interface circuit achieves the speed enhancement of the transmission of the data signals D0 to Dn to shorten the image data signal transmission period, thereby contracting the domain 21. That is, the same state as the state in FIG. 15 can be generated. However, the display domain of the image is not contracted in the actual screen. The fourth embodiment differs from the third embodiment in this point.

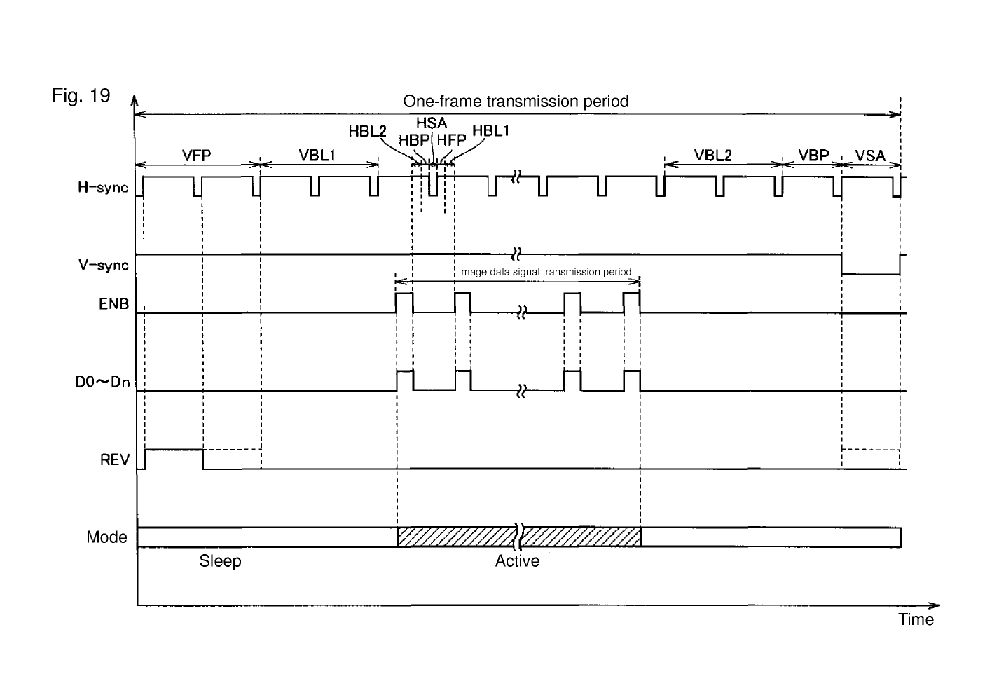

FIG. 19 is a timing chart illustrating an operation of the transmission unit 1 of the fourth embodiment. Referring to FIGS. 4 and 19, in the fourth embodiment, the data signal is transmitted by the differential serial transmission method, which allows the image data signal transmission time to be shortened without changing the one-frame data transmission period. Therefore, the horizontal blanking periods HBL1 and HBL2 and the vertical blanking periods VBL1 and VBL2 can be set.

According to the fourth embodiment, like the first to third embodiments, the power consumption of the transmission unit 1 can be reduced because the ratio of the sleep mode period to the one frame transmission period can be increased. The power consumption of the display device 5 can also be reduced in the one-frame transmission period.

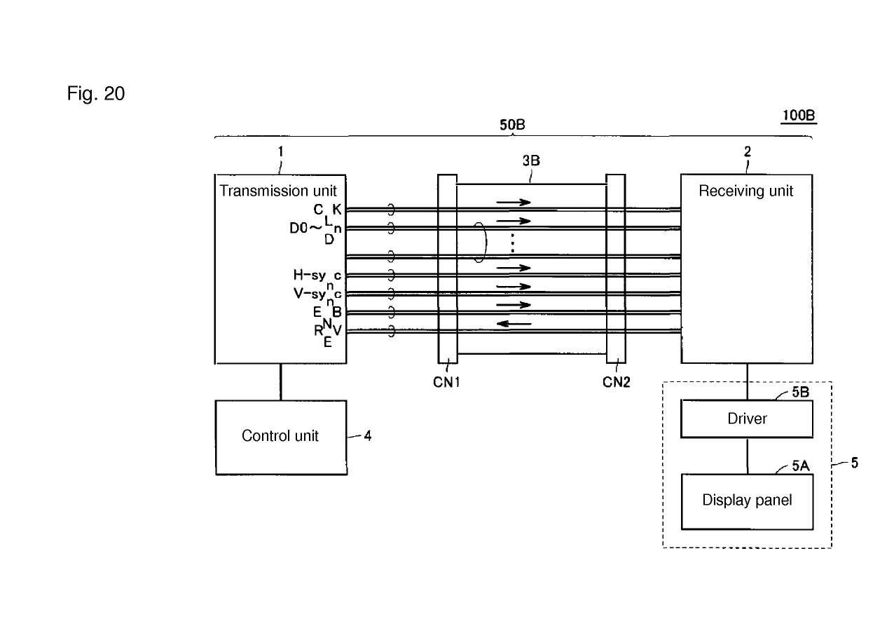

FIG. 20 is a view illustrating a modification of the fourth embodiment. Referring to FIGS. 16 and 20, an electronic device 100B differs from the electronic device 100A in that the electronic device 100E includes a data transmission system 50B instead of the data transmission system 50A. The data transmission system 50B differs from the data transmission system 50A in that the data transmission system 50B includes a wiring unit 3B instead of the wiring unit 3A. The wiring unit 3B is configured such that not only the data signal but also the control signal are transmitted through the wiring unit 3B by the differential serial transmission method. That is, not only the differential transmission lines are provided with respect to the clock signal CLK and the data signals D0 to Dn, but also the differential transmission lines are provided with respect to the horizontal synchronous signal H-sync, the vertical synchronous signal V-sync, the data enable signal ENB, and the signal REV.

### Fifth Embodiment

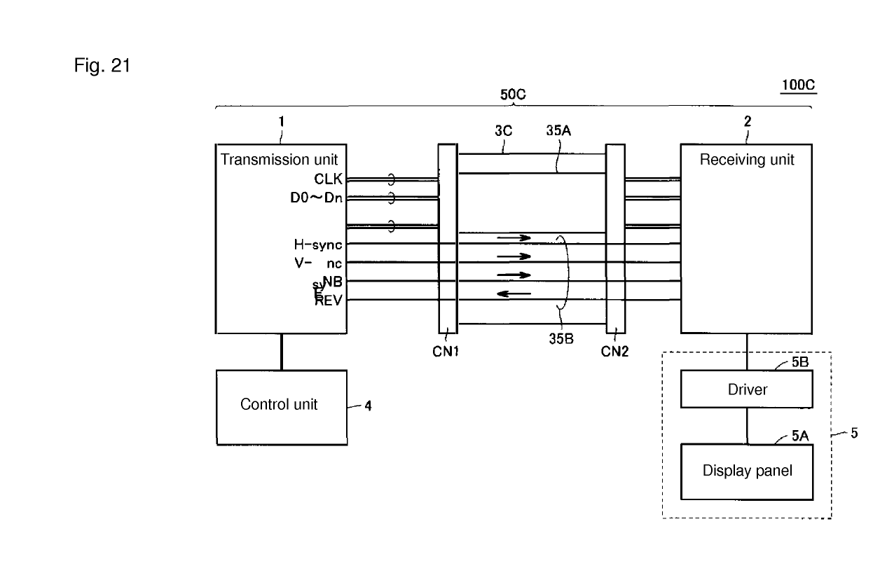

FIG. 21 is a view illustrating a schematic configuration of an electronic device including a transmission system according to a fifth embodiment. Referring to FIGS. 1 and 21, an electronic device 1000 differs from the electronic device 100 in that the electronic device 100C includes a data transmission system 50C instead of the data transmission system 50. The data transmission system 50C differs from the data transmission system 50 in that the data transmission system 500 includes a wiring unit 30 instead of the wiring unit 3.

The wiring unit 3C includes an optical wiring module 35A and an electric wiring unit 35B. In the fifth embodiment, the dock signal CLK and the data signals D0 to Dn are transmitted as optical signals in the optical wiring module 35A. The dock signal CLK and the data signals D0 to Dn, which are transmitted from the transmission unit 1, are electric signals. The optical wiring module 35A converts the electric signal into the optical signal. As described later, the optical signal is transmitted through the optical wiring. The optical signal transmitted through the optical wiring is converted into the electric signal by the optical wiring module 35A, and the electric signal is transmitted to the receiving unit 2. The electric wiring unit 35B includes electric wiring through which control signals such as the horizontal synchronous signal H-sync are transmitted as the electric signals.

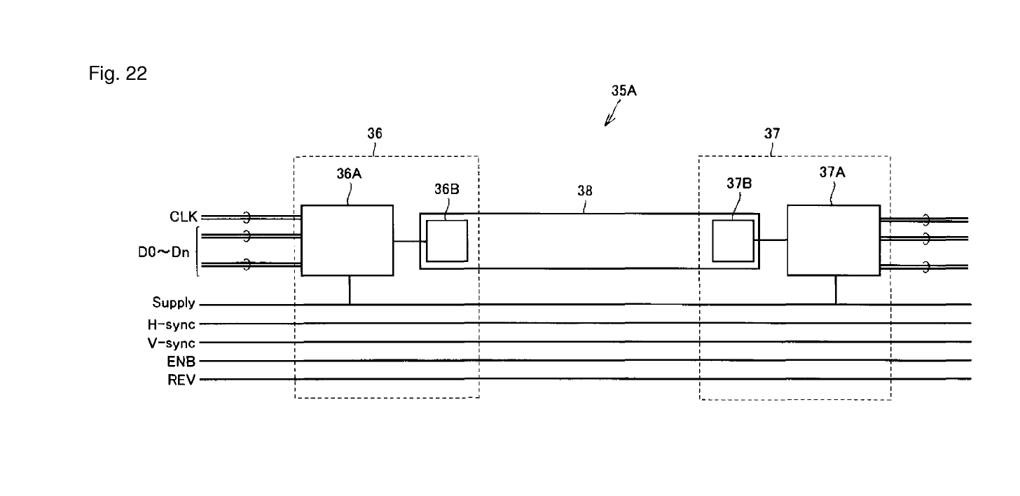

FIG. 22 is a view illustrating a configuration example of the optical wiring module in FIG. 21. Referring to FIG. 22, the optical wiring module 35A includes an optical transmission unit 36, an optical receiving unit 37, and an optical wiring 38. The optical transmission unit 36 includes a driving circuit 36A and a light source 36B.

The driving circuit 36A drives the light source 36B according to input signals (such as the dock signal CLK and the data signals D0 to Dn). The light source 36B emits light traveling in the optical wiring 38. Typically the light source 36B is a semiconductor laser. For example, the light source 36B includes a VCSEL (Vertical Cavity-Surface Emitting Laser).

The driving circuit 36A supplies a driving current to the light source 36B (the semiconductor laser), and modulates the driving current according to the signal input to the driving circuit 36A. Therefore, the light emitted from the light source 36B is modulated to generate the optical signal.

The optical wiring 38 is made of glass or resin. Among others, preferably resin materials, such as an acrylic resin, an epoxy resin, a urethane resin, and a silicone resin, are used as the optical wiring 38. The optical wiring having sufficient flexibility can be implemented using the resins. The optical wiring has sufficient flexibility so that the optical wiring 38 can easily be disposed when the optical wiring module 35A is mounted on the electronic device.

The optical receiving unit 37 includes a light receiving unit 37B and an amplifier 37A. The light receiving unit 37B receives the optical signal traveling through the optical wiring 38, and converts the optical signal into the electric signal. For example, the light receiving unit 37B is a photodiode. The amplifier 37A amplifies the electric signal output from the light receiving unit 37B.

According to the fifth embodiment, the optical wiring module is used to transmit the dock signal and the data signals D0 to Dn. Therefore, the signal transmission speed can be enhanced compared with the fourth embodiment. Preferably the transmission speed per lane through which one signal is transmitted is greater than or equal to 500 Mbps. In the fourth embodiment, the signal is transmitted by a serial interface (electric wiring) in which a differential voltage is used. However, for the low-voltage differential serial interface, the transmission speed per lane is about 500 Mbps at a maximum. On the other hand, in the fifth embodiment, the optical wiring through which the signal can be transmitted at high speed is inserted in the middle of the transmission line, which allows the length of the electric wiring unit to be shortened by the length of the optical wiring module. Therefore, a transmission loss is reduced and an influence of waveform degradation caused by a parasitic capacitance is also reduced, so that an upper limit of the transmission speed of the electric wiring unit can be enhanced. The optical wiring is smaller than the electric wiring in the transmission loss, and the signal is transmitted without the influence of EMI, so that the transmission speed can be enhanced in the optical wiring compared with the electric wiring. From this viewpoint, the transmission speed can be enhanced compared with the electric wiring unit. Accordingly, in the fifth embodiment, the transmission speed (the speed greater than or equal to 500 Mbps) higher than the transmission speed of the electric wiring can be achieved. Like the fourth embodiment, because the image data transmission period can be shortened, the ratio of the sleep mode period to the one-frame transmission period can be increased. Accordingly, the power consumption of the transmission unit 1 can be reduced. The power consumption of the display device 5 can also be reduced in the one-frame transmission period.

A resistant property of the signal against a noise (including an electromagnetic interference noise) can be enhanced using the optical wiring. Therefore, reliability of the transmission of the image data signal can be enhanced. For example, retransmission of the image data signal can be eliminated.

In the case that the serial data signal is transmitted at high speed, generally coding is required such that at least a given number of 0 or 1 is not continued in the serial data signal. In the case that the serial data signal is transmitted at high speed only by the electric wiring, the coding is required in the transmission unit 1 and the receiving unit 2. However, because the use of the optical wiring module can perform the coding in the optical wiring module, the coding can be eliminated in the transmission unit 1 and the receiving unit 2. Therefore, the power consumption can be reduced in the transmission unit 1 and the receiving unit 2. The necessity to add the coding function to the transmission unit 1 and the receiving unit 2 is eliminated, so that cost reduction of the transmission system can be achieved.

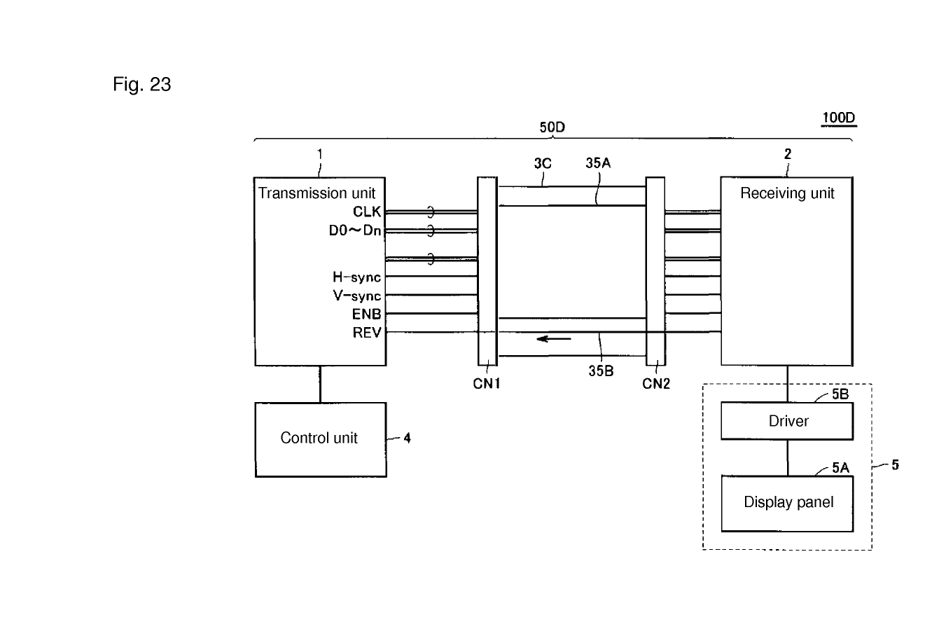

FIG. 23 is a view illustrating a modification of the fifth embodiment. Referring to FIGS. 21 and 23, an electronic device 100D differs from the electronic device 100C in that the electronic device 100D includes a data transmission system 50D instead of the data transmission system 50C. The data transmission system 50D includes the wiring unit 30. In the wiring unit 3C, the optical wiring module 35A transmits not only the image data signal (the dock signal CLK and the data signals D0 to Dn) but also the control signal (including the horizontal synchronous signal H-sync) in the form of the optical signal. In the configuration in FIG. 23, the signal REV is transmitted through the electric wiring unit 35B. Alternatively, the signal REV may be transmitted by the optical wiring module.

### Sixth Embodiment

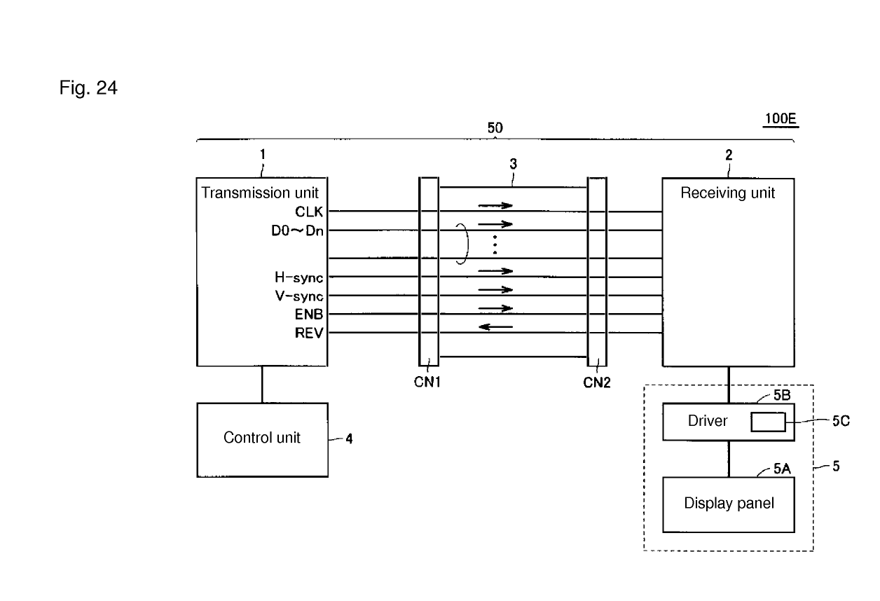

FIG. 24 is a view illustrating a schematic configuration of an electronic device according to a sixth embodiment, Referring to FIGS. 1 and 24, a basic configuration of an electronic device 100E is identical to the configuration of the electronic device 100. However, the driver 5B that drives the display panel 5A includes a memory 5C. The electronic device 100E differs from the electronic device 100 in this point.

In the configuration in FIG. 24, the electronic device 100E includes the data transmission system 50 of the first embodiment. Alternatively, the electronic device 100E may include one of the data transmission systems 50A to 50D instead of the data transmission system 50.

The data corresponding to the one-frame image transmitted from the transmission unit 1 is stored in the memory 5C. For example, the memory 5C is a frame memory. The memory 5C may be provided in the display device 5 while separated from the driver 5B. The image data stored in the memory 5C is used in the case that the driver 5B redraws (refreshes) the image displayed on the display panel 5A. On the other hand, in the case that the driver 5B changes the image displayed on the display panel 5A to a new image, the image data signal corresponding to the new image is transmitted from the transmission unit 1.

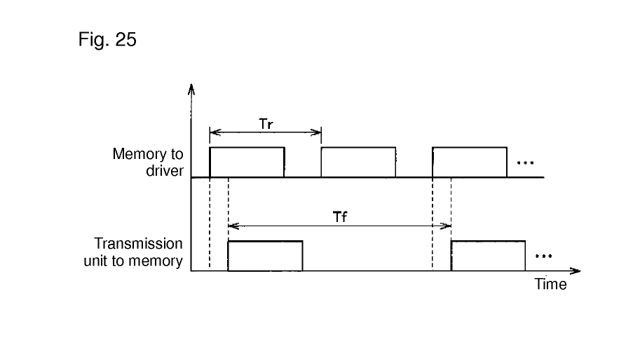

FIG. 25 is a view illustrating a refresh rate and the frame rate. Referring to FIGS. 24 and 25, a cycle Tr indicates a cycle at which the image data is transmitted from the memory 5C to the driver 5B. The refresh rate is an inverse number of the cycle Tr. A cycle Tf indicates a cycle at which the image data is transmitted from the transmission unit 1 to the memory 5C. The frame rate is an inverse number of the cycle Tf.

Generally the refresh rate is an integral multiple of the frame rate. While the display image is not changed, the image data is transmitted from the memory 5C to the driver 5B at the refresh rate. Therefore, according to the sixth embodiment, the power consumption of the transmission unit 1 can be reduced compared with the case that the transmission unit 1 transmits the image data signal at the refresh rate.

### Seventh Embodiment

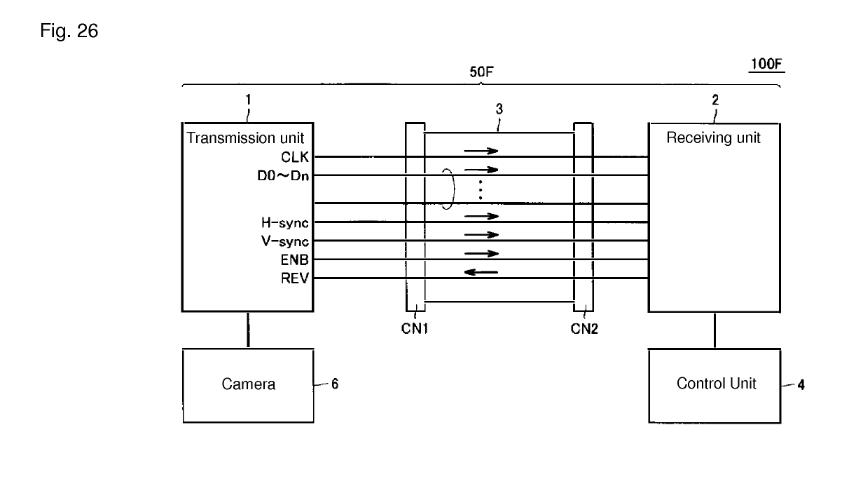

FIG. 26 is a view illustrating a schematic configuration of an electronic device according to a seventh embodiment. Referring to FIGS. 1 and 26, an electronic device 100F differs from the electronic device 100 in that the electronic device 100F includes a camera 6 instead of the display device 5. A data transmission system 50F differs from the data transmission system 50 of the first embodiment in that the image data is transmitted from the camera 6.

The camera 6 captures the image at a given frame rate (for example, 60 fps). The data transmission system 50F includes the transmission unit 1 that transmits the control signal while transmitting the one-frame image captured by the camera 6 as the image data signal, the receiving unit 2 that receives the data signal and the control signal, and the wiring unit 3 through which the image data signal and the control signal are transmitted. The transmission unit 1 transmits the clock signal CLK, the data signals D0 to Dn, the horizontal synchronous signal H-sync, the vertical synchronous signal V-sync, and the data enable signal ENB. The transmission unit 1 receives the signal REV from the receiving unit 2.

The receiving unit 2 transmits the clock signal CLK, the data signals D0 to Dn, the horizontal synchronous signal H-sync, the vertical synchronous signal V-sync, and the data enable signal ENB to the control unit 4. Based on these signals, the control unit 4 generates the image data to form, for example, the one-frame image.

The processing of transmitting the image data signal and the control signal, which is performed by the transmission unit 1, is identical to the processing of one of the first to third embodiments. The pieces of processing of the embodiments may properly be combined. Instead of the wiring unit 3, one of the wiring units 3A to 30 may be applied to the data transmission system 50F.

In the seventh embodiment, the transmission unit 1 acts as a master and the receiving unit 2 acts as a slave. That is, the receiving unit 2 passively receives the image data signal and control signal that are transmitted from the transmission unit 1. Alternatively, the receiving unit 2 may act as the master while the transmission unit 1 acts as the slave. That is, the receiving unit 2 may control the transmission unit 1 such that the transmission unit 1 transmits the image data signal and the control signal according to the processing of one of the first to third embodiments.

According to the seventh embodiment, the power consumption of the transmission unit 1 can be reduced in the one-frame transmission period. According to the seventh embodiment, the power consumption of the camera 6 can also be reduced in the one-frame transmission period.

### Eighth Embodiment

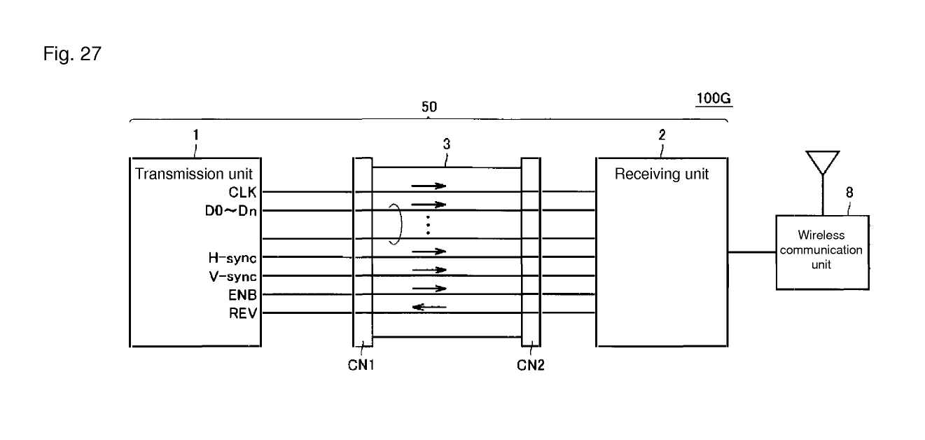

FIG. 27 is a view illustrating a schematic configuration of an electronic device according to an eighth embodiment. Referring to FIGS. 1 and 27, an electronic device 100G differs from the electronic device 100 in that the electronic device 100G includes a wireless communication unit 8. The wireless communication unit 8 receives the image data signal corresponding to each line of the one-frame image from the receiving unit 2, and transmits the image data corresponding to the one-frame image as a radio signal based on the image data signal.

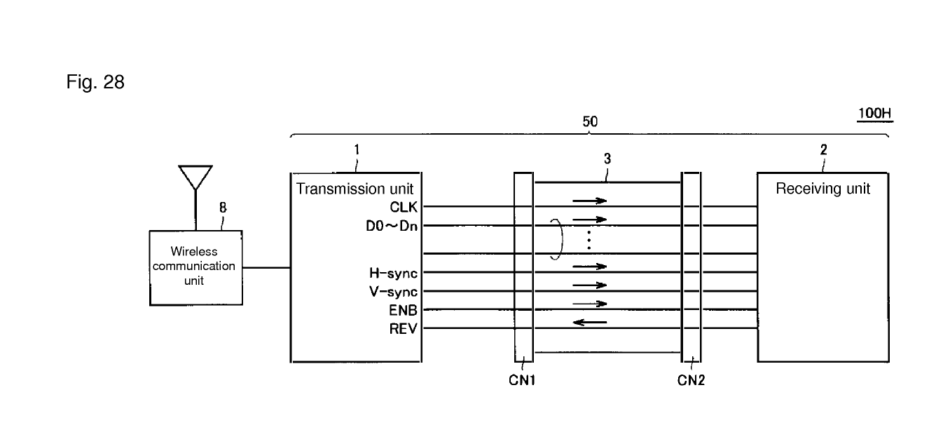

FIG. 28 is a view illustrating another configuration of the electronic device of the eighth embodiment. Referring to FIGS. 27 and 28, an electronic device 100H differs from the electronic device 100G in that the wireless communication unit 8 is connected to the transmission unit 1. According to the configuration in FIG. 28, the wireless communication unit 8 receives the image data corresponding to the one-frame image as the radio signal, and outputs the image data signal corresponding to each line of the image to the transmission unit 1.

The electronic devices 100G and 100H may include one of the data transmission systems 50A to 50D instead of the data transmission system 50. Although not illustrated, the electronic devices 100G and 100H may further include the display device 5 and/or the camera 6. The electronic devices 100G and 100H may includes the control unit 4 that transmits and receives the image data signal to and from the transmission unit 1 or the receiving unit 2.

According to the eighth embodiment, the power consumption of the transmission unit 1 can be reduced in the one-frame transmission period. According to the seventh embodiment, the power consumption of the wireless communication unit can also be reduced in the one-frame transmission period.

### Application Example

There is no particular limitation to the electronic device, to which the present invention can be applied, as long as the device includes the system that transmits the image data. Nowadays, there is a demand to reduce the power consumption of the device irrespective of the kind of the electronic device. The present invention is mounted on the device that includes the image data transmitting system, which allows the reduction of the power consumption of the device.

A mobile terminal device can be cited as a suitable example of the electronic device of the present invention. An operating time of the mobile terminal device is closely related to the power consumption of the device. The effect to lengthen the operation time of the mobile terminal device is enhanced by applying the present invention to the mobile terminal device. A mobile phone will be described below as an example of the electronic device of an embodiment of the present invention.

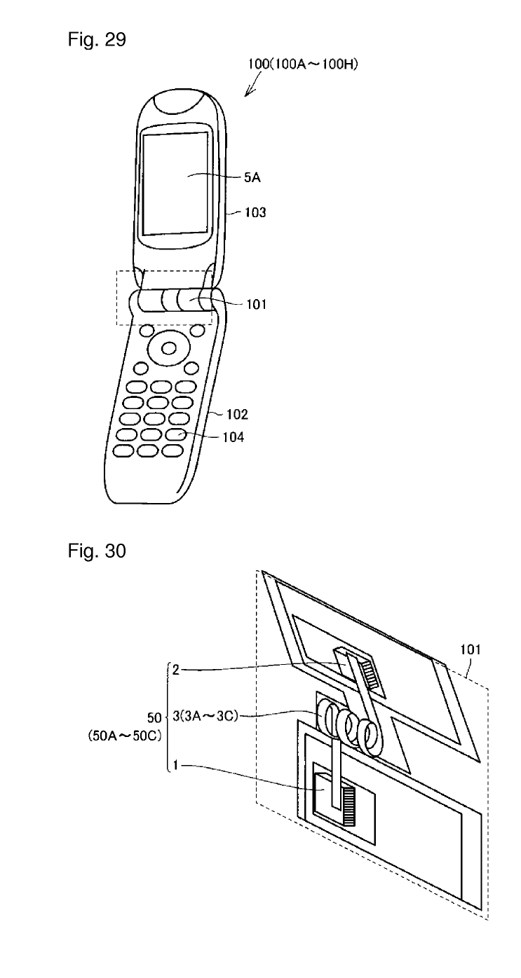

FIG. 29 is a perspective view illustrating a mobile phone that is of an example of the electronic device of an embodiment of the present invention when the mobile phone is viewed from a front direction. Referring to FIG. 29, the electronic device 100 is a folding mobile phone. The mobile phone includes a main body 102, a hinge 101 that is provided at one end of the main body 102, and a cover 103 that is rotatable about the hinge 101. The main body 102 includes a manipulation key 104 that manipulates the mobile phone. The cover 103 includes the display panel 5A, and the display panel 5A includes the driver 5B (not illustrated). The electronic devices 100A to 100H can be made as the mobile phone in FIG. 29. Although not illustrated in FIG. 29, the mobile phone includes the wireless communication unit 8 of the eighth embodiment.

FIG. 30 is a perspective plan view illustrating the hinge 101 in FIG. 29 and a peripheral portion thereof. Referring to FIGS. 29 and 30, the transmission unit 1 is mounted in the main body 102. On the other hand, the receiving unit 2 is mounted in the cover 103. The transmission unit 1 and the receiving unit 2 are connected to each other by the wiring unit 3. The wiring unit 3 has flexibility. The transmission unit 1, the receiving unit 2, and the wiring unit 3 constitute the data transmission system 50.

Instead of the data transmission system 50, one of the data transmission systems 50A to 500 may be mounted on the electronic device. Particularly, the data transmission system 50 includes the wiring unit 3C including the optical wiring module, which allows the image data signal to be transmitted at high speed. The reliability of the transmission of the image data signal can be enhanced because the noise-resistant property of the signal is enhanced.

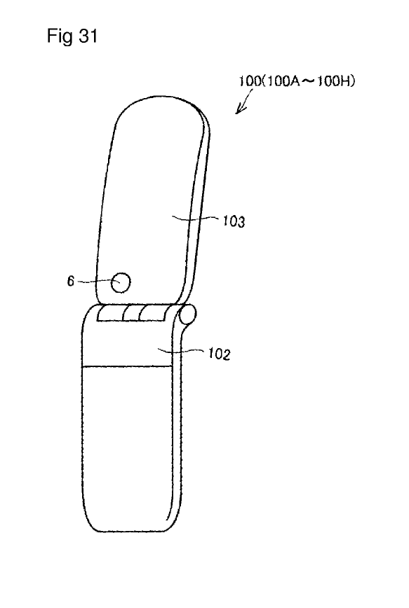

FIG. 31 is a perspective view illustrating the mobile phone in FIG. 29 when the mobile phone is viewed from a backside direction. Referring to FIG. 29, the camera 6 is provided in the cover 103 of the mobile phone (the electronic devices 100, 100A to 100H). However, there is no particular limitation to the position of the camera 6. The camera 6 obtains the image, and outputs the image data. Accordingly, the data transmission system (for example, the data transmission system 50F of the seventh embodiment) of the embodiments of the present invention can be applied in order to transmit the image data from the camera 6.

In the above embodiments, the display device is the liquid crystal display device. However, the display device is not limited to the liquid crystal display device. For example, an organic EL (electroluminescence) display can be applied to the embodiments of the present invention. Similarly, there is no limitation to the kind of the camera. For example, a CCD camera and a CMOS camera can be applied to the embodiments of the present invention.

The embodiments are disclosed only by way of example, and the present invention is not limited to the embodiments. The scope of the present invention is defined by not the embodiments but the claims, and it is noted that all changes equivalent to claims are included in the present invention.

1. An image data transmission system comprising:
a transmission unit that outputs a plurality of data signals and a control signal, the data signals being generated by dividing a one-frame image in given units, the control signal being used to control timing at which predetermined processing is performed based on the data signals;
a receiving unit that receives the data signals and the control signal; and
a wiring unit through which the data signals and the control signal are transmitted from the transmission unit to the receiving unit, wherein
the transmission unit sequentially outputs the plurality of data signals in a predetermined transmission period during which the one-frame image is transmitted, the predetermined transmission period being defined by a product of a number of the given units and a transmission period of the given unit, the transmission unit outputs the control signal in a first period of first and second periods, the data signals being not output in the first and second periods,
the first period is a period that is equal to a sum of transmission time of the given units which does not include the data signals in the predetermined transmission period, and
when the first period is defined as a sleep mode period of the transmission unit, the sleep mode period is set such that a ratio of the sleep mode period to the predetermined transmission period is larger than a ratio of a sum of a transmission period of the control signal and a margin period for transmission of the control signal to the predetermined transmission period.

2. An image data transmission system comprising:
a transmission unit that outputs a plurality of data signals and a control signal, the data signals being generated by dividing a one-frame image in given units, the control signal being used to control timing at which predetermined processing is performed based on the data signals;
a receiving unit that receives the data signals and the control signal; and
a wiring unit through which the data signals and the control signal are transmitted from the transmission unit to the receiving unit, wherein
the transmission unit sequentially outputs the plurality of data signals in a predetermined transmission period during which the one-frame image is transmitted, the predetermined transmission period being defined by a product of a number of the given units and a transmission period of one given unit, the transmission unit outputs the control signal in a second period of first and second periods, the data signals being not output in the first and second periods,
the first period is a period that is equal to a sum of transmission time of the given units which does not include the data signals in the predetermined transmission period,
the second period is a period that is equal to a sum of time difference obtained by subtracting transmission periods of the data signals from a transmission period of the given units including the data signals in the predetermined transmission period, and
when the second period is defined as a sleep mode period of the transmission unit, the sleep mode period is set such that a ratio of the sleep mode period to the predetermined transmission period is larger than a ratio of a sum of a transmission period of the control signal and a margin period for transmission of the control signal to the predetermined transmission period.

3. The image data transmission system according to claim 1, wherein
the transmission unit outputs the control signal in both the first and second periods, and
when the first and second periods are defined as the sleep mode period, the sleep mode period is set such that a ratio of the sleep mode period to the predetermined transmission period is larger than a ratio of a sum of a transmission period of the control signal and a margin period for transmission of the control signal to the predetermined transmission period.

4. The image data transmission system according to claim 1, wherein
the control signal transmitted in the first period includes a vertical synchronous signal, and
a sum of a transmission period of the vertical synchronous signal and the margin period for transmission of the vertical synchronous signal is less than or equal to 20% of the predetermined transmission period.

5. The image data transmission system according to claim 2, wherein
the control signal transmitted in the second period includes a horizontal synchronous signal, and
the margin period for transmission of the horizontal synchronous signal is less than or equal to ten times a transmission period of the horizontal synchronous signal.

6. An image data transmission system comprising:
a transmission unit that outputs a plurality of data signals and a control signal, the data signals being generated by dividing a one-frame image in given units, the control signal being used to control timing at which predetermined processing is performed based on the data signals;
a receiving unit that receives the data signals and the control signal; and
a wiring unit through which the data signals and the control signal are transmitted from the transmission unit to the receiving unit, wherein
the transmission unit includes first and second transmission modes in which the plurality of data signals are sequentially output in a predetermined transmission period during which the one-frame image is transmitted, the transmission unit transitions to a sleep mode in which power consumption of the transmission unit is low compared with an output time of the data signals when the output of the data signals is stopped, and
the transmission unit enhances a transmission speed of the data signals in the second transmission mode compared with the first transmission mode, whereby the transmission unit increases a ratio of the sleep mode period to the predetermined transmission period compared with the ratio in the first transmission mode.

7. The image data transmission system according to claim 1, wherein a rate of increase in power consumption of the transmission unit is less than or equal to a proportion of a second speed to a first speed when a transmission speed of the transmission unit increases from the first speed to the second speed.

8. The image data transmission system according to claim 1, wherein the transmission unit sets a period, during which both the data signals and the control signal are not transmitted, in the sleep mode period.

9. The image data transmission system according to claim 1, wherein
the given unit is one line, and
a transmission period corresponding to the one line and the sleep mode period are integral multiples of a cycle of a clock signal used in the transmission unit.

10. The image data transmission system according to claim 1, wherein the wiring unit includes signal wiring that is configured to transmit at least the data signals of the data signals and the control signal by a differential serial transmission method.

11. The image data transmission system according to claim 1, wherein the wiring unit includes an optical wiring module that transmits at least the data signals of the data signals and the control signal in a form of an optical signal.

12. The image data transmission system according to claim 11, wherein a transmission speed per lane of the optical wiring module is greater than or equal to 500 Mbps.

13. The image data transmission system according to claim 1, wherein
the receiving unit outputs the data signals and the control signal to a display device, and
the predetermined processing is processing of displaying the one-frame image, which is performed by the display device.

14. The image data transmission system according to claim 13, wherein
the display device includes a memory, and
data of the one-frame image corresponding to the data signals is stored in the memory.

15. The image data transmission system according to claim 1, wherein the transmission unit transmits the data signals corresponding to an image captured by a camera.

16. The image data transmission system according to claim 1, wherein the transmission unit data corresponding to the one-frame image, which is received by a wireless communication unit, as the data signals.

17. The image data transmission system according to claim 1, wherein
the receiving unit outputs the data signals to a wireless communication unit, and
the wireless communication unit wirelessly transmits the data signals.

18. An electronic device comprising the image data transmission system according to claim 1.

19. The electronic device according to claim 18, wherein the electronic device is a mobile terminal device.
